(19) United States
(12) Patent Application Publication
(10) Pub. No.: US 2026/0315869 A1
(43) Pub. Date: Oct. 15, 2026

(54) METHOD FOR COLLECTING INFORMATION REGARDING LOCATION OF SPORTS PLAYERS IN REAL-TIME

(71) Applicant: FITOGETHER INC., Seoul (KR)

(72) Inventors: Jae Chan LEE, Yongin-si (KR); Chul Woo PARK, Seoul (KR); Jae Bok SHIN, Suwon-si (KR); Hyuk Jung KIM, Seoul (KR)

(73) Assignee: FITOGETHER INC., Seoul (KR)

(21) Appl. No.: 19/106,779

(22) PCT Filed: Dec. 5, 2023
(86) PCT No.: PCT/KR2023/019843

§ 371 Date: Feb. 26, 2025

(30) Foreign Application Priority Data
Dec. 5, 2023 (KR) 10-2023-0173942
Dec. 5, 2023 (KR) 10-2023-0173943

(51) Int. Cl. A63B 24/00; G01S 19/42

(52) U.S. Cl. CPC A63B 24/0021; G01S 19/42; A63B 2024/0025; A63B 2220/12; A63B 2220/40; A63B 2230/06

(57) ABSTRACT

Provided is a method for collecting information on the location of a sports player in real-time. The method comprises acquiring, based on a positioning sensor, information on the location of a player at a plurality of time points according to a predetermined time interval and at least one positioning state characteristic value, wherein the positioning state characteristic value includes information on the positioning state at the time the positioning sensor determines locational information of the player; and determining validity of the information on the location of the player based on the positioning state characteristic value acquired from the positioning sensor.

### TECHNICAL FIELD

The present disclosure generally relates to analysis of a sports event and, more specifically but not exclusively, to a technique for collecting information on the location of a sports player in real-time.

### BACKGROUND

The importance of sports analysis is gradually increasing due to the explosive growth of the sports industry market and the development of sports science. Amid this trend, Electronic Performance Tracking Systems (EPTS) that track sports players during games or training sessions have been introduced one after another, particularly in major sports such as soccer. In EPTS, the position and movement of a sports player are used as important basic data for providing various supplementary information; consequently, various efforts have been made to facilitate the acquisition of tracking information on the positions of sports players and to improve its accuracy. In relation to the description above, methods for determining the position of an object based on the characteristics of signals measured by sensors corresponding to the object, such as the Global Positioning System (GPS), have been widely used.

Meanwhile, the conventional practice of sports analysis and information provision primarily relies on post-event analysis, where data collected during a game is processed and analyzed after the game to provide information to users. However, recently, there has been growing demand for real-time sports analysis and information provision for various purposes, including assistance to decision-making during games and controlling the appropriate intensity of training.

### DISCLOSURE

### Technical Problem

In what follows, a summary of specific embodiments of the present disclosure is provided. The aspects presented in the summary below are merely intended to provide a brief overview of specific embodiments and should not be construed as limiting the scope of the present disclosure. Accordingly, it is to be understood that the present disclosure may further include various aspects not explicitly set forth below.

The present disclosure and the concepts thereof disclosed below provide methods, devices, and computer-readable storage media for displaying player information on a sports video.

One object of the present disclosure is to provide a method and a device for collecting information on the location of a sports player in real-time to perform sports analysis in real-time and provide related information.

Also, one object of the present disclosure is to provide a procedure for determining validity of information on the location of a sports player based on the information on the positioning state of a positioning sensor at the time of locational information measurement, wherein information on the location of the sports player is collected in real-time.

Also, one object of the present disclosure is to provide a procedure for determining validity of information on the location of a sports player based on assessment of a target's movement using an inertial sensor wherein information on the location of the sports player is collected in real-time.

Also, one object of the present disclosure is to provide a procedure for obtaining more accurate real-time locational information by performing preprocessing utilizing positioning information prior to a target time point wherein information on the location of the sports player is collected in real-time.

Also, one object of the present disclosure is to provide a data processing procedure for post-event and/or real-time analysis to ensure consistency between the information provided through post-event analysis and real-time analysis.

However, the technical problem to be solved by the present disclosure is not limited to the above but may be extended to other various problems belonging to the scope not departing from the technical principles and domain of the present disclosure.

### Technical Solution

Embodiments include methods, devices, and computer-readable storage media for displaying player information on a sports video.

According to one embodiment, a method performed by a computing device for collecting information on the location of a sports player in real-time is provided wherein the validity of the collected information is determined based on an inertial sensor. The method may comprise acquiring, based on a positioning sensor, information on the location of a player at a plurality of time points according to a predetermined time interval and at least one positioning state characteristic value, wherein the positioning state characteristic value includes information on the positioning state at the time the positioning sensor determines locational information of the player; and determining validity of the information on the location of the player based on the positioning state characteristic value acquired from the positioning sensor.

According to another embodiment, a method performed by a computing device for collecting information on a sports player in real-time is provided, wherein the validity of data is determined based on an inertial sensor. The method may comprise collecting information on a sports player at a first time point based on a first sensor; collecting information on whether movement of the inertial sensor is present at the first time point based on the inertial sensor; and determining validity of the information on the sports player based on the information on whether movement of the inertial sensor is present.

According to another embodiment, a method performed by a computing device for collecting information on the location of a sports player in real-time is provided. The method may comprise acquiring, based on a positioning sensor, information on the location of a player at a plurality of time points according to a predetermined time interval; and determining processed locational information for the target time point based on the information on the location of the player measured at a predetermined number of time points preceding the target time point.

Other exemplary embodiments, different from the exemplary embodiments given above, will be described or become apparent through detailed descriptions to be given below with respect to the exemplary embodiments to be read in conjunction with accompanying drawings.

### Advantageous Effects

The present disclosure may provide the following effects. However, since it is not meant that a specific embodiment has to provide all of or only the following effects, the technical scope of the present disclosure should not be regarded as being limited by the specific embodiment.

According to an embodiment of the present disclosure, by collecting information on the location of a sports player in real-time, sports analysis may be performed in real-time, and related information may be provided.

Also, by collecting information on the location of a sports player in real-time wherein the validity of the information on the location of the sports player is determined based on information on the positioning state of a positioning sensor at the time of locational information measurement, abnormal locational information may be filtered out, and the accuracy of the locational information of the sports player may be improved.

Also, according to the present disclosure, by determining whether a target is moving based on an inertial sensor and determining validity of the information on the location of the sports player based on the determination, the GPS ghosting issue, where displacement is erroneously measured from a stationary device, may be addressed.

Also, according to the present disclosure, by performing preprocessing utilizing positioning information preceding the target time point, real-time locational information with improved accuracy may be acquired.

Also, according to the present disclosure, by appropriately designing a data processing procedure for post-analysis and/or real-time analysis, consistency may be ensured between the information provided through post-event analysis and real-time analysis.

The foregoing description of the present disclosure does not constitute a complete list of all aspects of the present disclosure. The present disclosure should be understood to include not only the matters summarized above but also all possible implementations of methods, devices, and systems derived from appropriate combinations of the various aspects disclosed in the detailed descriptions and appended claims provided below.

### BRIEF DESCRIPTION OF THE DRAWINGS

FIG. 1 illustrates acquisition of sensor-based locational information.

FIG. 2 illustrates an exemplary system in which a method for collecting information on the location of a sports player in real-time according to one embodiment of the present disclosure may be performed.

FIG. 3 is a block diagram of a sensor device that may be used for collecting information on the location of a sports player according to one embodiment of the present disclosure.

FIG. 4 is a block diagram of a server according to one embodiment of the present disclosure.

FIG. 5 is a block diagram illustrating the structure of an exemplary system for post-analysis of a sports event.

FIG. 6 illustrates the structure of an exemplary system for real-time analysis of a sports event.

FIG. 7 illustrates a procedure for collecting information on the location of a sports player in real-time according to one embodiment of the present disclosure.

FIG. 8 illustrates missing value imputation according to one embodiment of the present disclosure.

FIG. 9 illustrates preprocessing of data according to one embodiment of the present disclosure.

FIG. 10 illustrates a Laplacian distribution.

FIG. 11 illustrates an exemplary structure of a live packet according to one embodiment of the present disclosure.

FIG. 12 illustrate preprocessing for speed information according to one embodiment of the present disclosure.

FIG. 13 illustrates preprocessing for acceleration information according to one embodiment of the present disclosure.

FIG. 14 illustrates a location measurement result for a stationary device using a conventional GPS device.

FIG. 15 illustrates a location measurement result for a stationary device according to one embodiment of the present disclosure.

FIG. 16 illustrates an example of abnormal measurements related to positioning.

FIG. 17 illustrates a step function.

FIG. 18 illustrates a delta function.

FIG. 19 illustrates validity determination criteria for locational information of a player according to one embodiment of the present disclosure.

FIG. 20 illustrates a threshold time length for validity determination of locational information of a player according to one embodiment of the present disclosure.

FIG. 21 is a schematic flowchart of a procedure for determining validity of information on the location of a sports player according to one embodiment of the present disclosure.

FIG. 22 is a detailed flowchart of the validity determination in FIG. 21.

FIG. 23 is a schematic flowchart of a procedure for determining validity of information on the location of a sports player based on an inertial sensor according to one embodiment of the present disclosure.

FIG. 24 is a schematic flowchart of a procedure for collecting information on the location of a sports player in real-time based on preprocessing according to one embodiment of the present disclosure.

FIG. 25 is a detailed flowchart of the determining of processed locational information at the target time point in FIG. 24.

FIG. 26 is a block diagram illustrating an exemplary structure of a computing system in which the method according to one embodiment of the present disclosure may be performed.

### EMBODIMENTS

Since the present disclosure may be modified in various ways and may provide various embodiments, specific embodiments will be depicted in the appended drawings and described in detail with reference to the drawings.

However, it should be understood that the specific embodiments are not intended to limit the gist of the present disclosure to the specific embodiments; rather, it should be understood that the specific embodiments include all of the modifications, equivalents, and/or alternatives of the embodiments of the present disclosure.

The terms such as first and second are introduced to describe various elements, but the elements should not be limited by the terms. The terms are used only for the purpose of distinguishing one element from the other elements. For example, a first element may be called a second element without leaving the technical scope of the present disclosure, and similarly, the second element may be called the first element. The term and/or includes any one of a combination of a plurality of related disclosed elements or a plurality of related disclosed elements.

If an element is said to be “connected” or “attached” to a different element, the former may be connected or attached directly to the different element, but another element may be present between the two elements. On the other hand, if an element is said to be “directly connected” or “directly attached” to a different element, it should be understood that there is no other element between the two elements.

Terms used in this document are intended only for describing a specific embodiment and are not intended to limit the technical scope of the present disclosure. A singular expression should be understood to indicate a plural expression unless otherwise explicitly stated. The term “include” or “have” is used to indicate existence of an embodied feature, number, step, operation, element, component, or a combination thereof; and should not be understood to preclude the existence or possibility of adding one or more other features, numbers, steps, operations, elements, components, or a combination thereof.

Unless defined otherwise, all the terms used in the present disclosure, including technical or scientific terms, provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

In what follows, with reference to appended drawings, preferred embodiments of the present disclosure will be described in more detail. In describing the present disclosure, to help overall understanding, the same reference symbols are used for the same elements in the drawings, and repeated descriptions of the same elements will be omitted.

Since the embodiments described in the present document are intended to clearly explain the technical principles of the present disclosure to those skilled in the art to which the present disclosure belongs, it should be understood that the present disclosure is not limited to the embodiments described in this document, and the scope of the present disclosure should be interpreted to include modified or altered examples that do not depart from the technical principles of the present disclosure.

The terms used in the present disclosure have been selected from commonly used and widely accepted terms that best describe the technical field to which the present disclosure belongs; however, it should be noted that the meanings of terms may vary depending on the intention of those persons skilled in the technical field to which the present disclosure belongs, precedents, or emergence of new technologies. Meanwhile, different from the above, when some terms may be defined arbitrarily by the applicant, definitions of the terms will be provided in the corresponding description of the present disclosure. Therefore, the terms used in the present disclosure should be interpreted not simply by their apparent name but based on their meaning and context throughout the present disclosure.

The appended drawings of the present disclosure are provided to facilitate the description of the present disclosure, and the shapes illustrated therein may be exaggerated or simplified as necessary for better understanding of the present disclosure; therefore, it should be understood that the present disclosure is not limited by the appended drawings.

In describing the present disclosure, if it is determined that a detailed description of known configurations or functions related to the present disclosure unnecessarily obscure the gist of the present disclosure, the detailed description thereof will be omitted.

A method for collecting information on the location of a sports player in real-time according to one aspect of the present disclosure may comprise acquiring, based on a positioning sensor, information on the location of a player at a plurality of time points according to a predetermined time interval and at least one positioning state characteristic value, wherein the positioning state characteristic value includes information on the positioning state at the time the positioning sensor determines locational information of the player; and determining validity of the information on the location of the player based on the positioning state characteristic value acquired from the positioning sensor.

According to one aspect, the positioning sensor may be a Global Navigation Satellite System (GNSS) sensor.

According to one aspect, the positioning state characteristic value may include at least one of information on the number of satellites used for positioning by the positioning sensor, information on the positioning mode of the positioning sensor, accuracy information on the vertical position of the positioning sensor, or information on the strength of satellite signals received by the positioning sensor.

According to one aspect, the determining of the validity of the information on the location of the player may include determining that a first condition for the positioning state characteristic value is not satisfied at a first time point; and determining that information on the location of the player obtained after a second time point is invalid in response to the determination that the first condition is not satisfied continuously until the second time point, which is the time point after a predetermined threshold time interval from the first time point.

According to one aspect, the determining of the validity of the information on the location of the player may further include determining that information on the location of the player obtained after the third time point is valid, wherein the third time point is the first time at which the first condition is satisfied after the second time point.

According to one aspect, the first condition may state that all specific conditions for a plurality of positioning state characteristic values included in the first condition are satisfied.

According to one aspect, the specific conditions may include whether the number of satellites used for positioning by the positioning sensor is six or more.

According to one aspect, the specific conditions may further include whether the positioning mode of the positioning sensor is RTK-GPS mode or normal mode.

According to one aspect, the specific conditions may further include whether accuracy of a vertical position of the positioning sensor is 3 m or less.

According to one aspect, the specific conditions may further include whether the strength of the satellite signal received by the positioning sensor is 20 dB or higher.

According to one aspect, the computing device may be a wearable device attached to a sports player.

A device for collecting information on the location of a sports player in real-time according to one aspect of the present disclosure may include a processor and a memory, wherein the processor may be configured to acquire, based on a positioning sensor, information on the location of a player at a plurality of time points according to a predetermined time interval and at least one positioning state characteristic value, wherein the positioning state characteristic value includes information on the positioning state at the time the positioning sensor determines locational information of the player; and determine validity of the information on the location of the player based on the positioning state characteristic value acquired from the positioning sensor.

A computer-readable storage medium including commands executable by a processor according to one aspect of the present disclosure, wherein the commands are intended to collect information on the location of a sports player in real-time and, by being executed by the processor, are configured to instruct the processor to acquire, based on a positioning sensor, information on the location of a player at a plurality of time points according to a predetermined time interval and at least one positioning state characteristic value, wherein the positioning state characteristic value includes information on the positioning state at the time the positioning sensor determines locational information of the player; and determine validity of the information on the location of the player based on the positioning state characteristic value acquired from the positioning sensor.

A method for collecting information on a sports player in real-time according to one aspect of the present disclosure may comprise collecting information on the sports player at a first time point based on a first sensor; collecting information on whether movement of an inertial sensor is present at the first time point based on the inertial sensor; and determining validity of the information on the sports player based on the information on whether movement of the inertial sensor is present.

According to one aspect, the first sensor may be a Global Navigation Satellite System (GNSS) sensor, the information on the sports player may be information on the speed of the sports player, and the determining of the validity of the information on the sports player may be configured to change the information on the speed of the sports player to zero in response to the determination that no movement of the inertial sensor is present and that the speed of the sports player is below a predetermined threshold.

According to one aspect, the first sensor may be a heart rate (HR) sensor, the information on the sports player may be information on the heart rate of the sports player, and the determining of the validity of the information on the sports player may be configured to change the information on the heart rate of the sports player to zero in response to the determination that no movement of the inertial sensor is present.

A device for collecting information on the location of a sports player in real-time according to one aspect of the present disclosure may comprise a processor and a memory, wherein the processor may be configured to collect information on the sports player at a first time point based on a first sensor; collect information on whether movement of an inertial sensor is present at the first time point based on the inertial sensor; and determine validity of the information on the sports player based on the information on whether movement of the inertial sensor is present.

A computer-readable storage medium including commands executable by a processor according to one aspect of the present disclosure, wherein the commands are intended to collect information on a sports player in real-time and, by being executed by the processor, are configured to instruct the processor to collect information on the sports player at a first time point based on a first sensor; collect information on whether movement of an inertial sensor is present at the first time point based on the inertial sensor; and determine validity of the information on the sports player based on the information on whether movement of the inertial sensor is present.

A method for collecting information on the location of a sports player in real-time according to one aspect of the present disclosure may comprise acquiring, based on a positioning sensor, information on the location of a player at a plurality of time points according to a predetermined time interval; and determining processed locational information for the target time point based on the information on the location of the player measured at a predetermined number of time points preceding the target time point.

According to one aspect, the positioning sensor may be a Global Navigation Satellite System (GNSS) sensor.

According to one aspect, the information on the location of the player may include the speed value of the player.

According to one aspect, the processed locational information for the target time point may be determined independently of the information on the location of the player measured after the target time point.

According to one aspect, the processed locational information for the target time point may be determined by multiplying the information on the location of the player measured at each of the predetermined number of time points by different weights and summing the multiplication results.

According to one aspect, the weights may be determined based on a Laplacian distribution or a Gaussian distribution.

According to one aspect, the computing device may be a wearable device attached to a sports player.

According to one aspect, the predetermined number may be determined by considering the sampling period of the positioning sensor and the data transmission period of the computing device.

According to one aspect, the predetermined number may be determined so as not to cause a waiting time according to the data transmission period of the computing device by processing the information on the location based on the sampling period of the positioning sensor.

According to one aspect, the predetermined number may be determined to be the same as the number of pieces of locational information included in a single packet according to the data transmission period of the computing device.

According to one aspect, the acquiring of the information on the location of the player at a plurality of time points may be configured to replace the information on the location of the player at a first time point, which is missing based on the predetermined time interval, with the information on the location of the player at a previous time point before the first time point.

According to one aspect, the missing data may be caused by a discrepancy between the sampling period of the positioning sensor and the predetermined time interval.

According to one aspect, the determining of the processed locational information for the target time point may include determining the processed locational information for the target time point as a first error value in response to the determination that the information on the location of the player measured based on the positioning sensor at the target time point is invalid.

According to one aspect, the determining of the processed locational information for the target time point may further include determining the processed locational information for the target time point as a second error value in response to the determination that at least one of the pieces of information on the location of the player measured at a predetermined number of time points preceding the target time point is invalid.

According to one aspect, the determining of the processed locational information for the target time point may further include determining the processed locational information for the target time point as a third error value in response to the determination that the number of pieces of information on the location of the player measured at time points preceding the target time point is smaller than the predetermined number of time points.

A device for collecting information on the location of a sports player in real-time according to one aspect of the present disclosure may include a processor and a memory, wherein the processor may be configured to acquire, based on a positioning sensor, information on the location of a player at a plurality of time points according to a predetermined time interval; and determine processed locational information for the target time point based on the information on the location of the player measured at a predetermined number of time points preceding the target time point.

A computer-readable storage medium including commands executable by a processor according to one aspect of the present disclosure, wherein the commands are intended to collect information on the location of a sports player in real-time and, by being executed by the processor, are configured to instruct the processor to acquire, based on a positioning sensor, information on the location of a player at a plurality of time points according to a predetermined time interval; and determine processed locational information for the target time point based on the information on the location of the player measured at a predetermined number of time points preceding the target time point.

### Acquisition of Locational Information

As described above, the importance of sports analysis is gradually increasing due to the explosive growth of the sports industry market and the development of sports science. Amid this trend, Electronic Performance Tracking Systems (EPTS) that track sports players during games or training sessions have been introduced one after another, particularly in major sports such as soccer. In EPTS, the position and movement of a sports player are used as important basic data for providing various supplementary information; consequently, various efforts have been made to facilitate the acquisition of tracking information on the positions of sports players and to improve its accuracy.

More specifically, just as in many other industries, data science has begun to be used as a crucial tool in the sports industry, where the primary types of data utilized in sports may be classified into event data and tracking data. Event data may include information related to ball-related events occurring during a sports match, while tracking data may include collected positional information of each player over specific time intervals.

In dynamic team sports such as soccer, basketball, or ice hockey, player tracking data may provide rich information that may be overlooked when event data alone are used, such as interactions between players and off-the-ball movements. For example, in a soccer game, various applications may be utilized based on the player tracking data, including formation and role estimation, space control analysis, play style identification, and foul prediction.

Recently, different types of tracking systems, such as the Global Positioning System (GPS), Local Positioning System (LPS), or Optical Tracking System (OTS) based on a plurality of cameras, have been proposed and successfully adopted for soccer games to obtain the tracking data.

GPS has the advantages of lower cost and easy installation compared to other methods but is known to be more susceptible to environmental factors such as weather and stadium conditions. On the other hand, OTS may provide more accurate tracking information if a sufficiently large number of high-resolution cameras are installed around the stadium at different angles. However, installing OTS equipment in all stadiums is not easy, and it is particularly challenging to equip training fields or away-game stadiums with OTS facilities. Furthermore, when it is attempted to implement OTS with a limited number of cameras, low-quality raw data may be obtained, which may result in requiring a manual correction process and thus prevent the acquisition of reliable tracking data.

Meanwhile, as described above, unlike conventional approaches that primarily relies on post-analysis of sports events, demand for real-time sports analysis and information provision is increasing. In this regard, according to embodiments of the present disclosure, procedures for collecting information on the location of a sports player in real-time with enhanced accuracy to perform real-time sports analysis are provided, and furthermore, procedures for improving consistency between real-time sports analysis results and post-analysis results are provided.

Although embodiments of the present disclosure are primarily described based on the use of sensor-based locational information, the present disclosure is not limited to the description; it should be understood that, except for specific procedures applicable only to sensor-based locational information, the present disclosure may also be applied to image-based positioning methods.

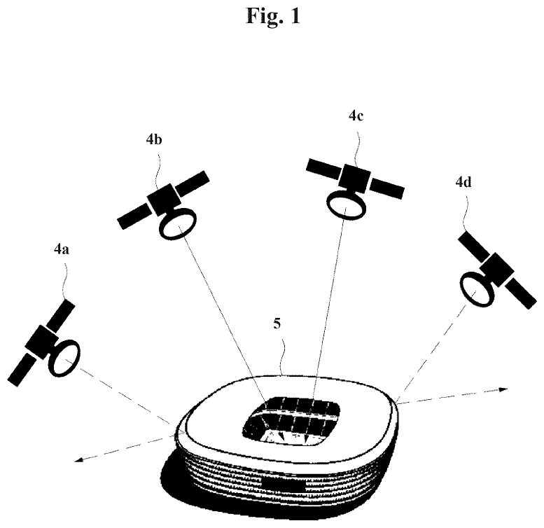

FIG. 1 illustrates acquisition of sensor-based locational information. As shown in FIG. 1, a positioning method that calculates the location of a player using sensor-based positioning devices, such as a GPS module, may be utilized.

Specifically, the positioning method using a GPS module calculates the location of a player to be tracked by relying on signals transmitted from satellites 4a, 4b, 4c, and 4d. In this case, the signals transmitted from satellites are affected by surrounding structures near the player being tracked.

For example, GPS signals transmitted from a part of satellites 4b and 4c of FIG. 1 may be transmitted into the stadium without being affected by surrounding structures near the player being tracked. However, GPS signals transmitted from the other part of satellites 4a and 4d of FIG. 1 may be obstructed by surrounding structures near the player being tracked and fail to reach the interior of the stadium. When GPS signals transmitted from satellites 4a and 4d are influenced by surrounding structures, an error may occur in the player's position calculated based on the received GPS signals.

In post-event sports analysis, various mechanisms have been applied to account for such errors. However, since error correction procedures have also to be performed in real-time to perform real-time sports analysis, various mechanisms applied to the post-event analysis may not be used directly. According to embodiments of the present disclosure, procedures for determining validity of collected data while performing real-time analysis are disclosed.

For example, according to an embodiment of the present disclosure, information on the location of a sports player is collected in real-time, and sports analysis is performed in real-time to provide related information, wherein, by determining validity of the locational data of the sports player based on the information on the positioning state of a positioning sensor at the time the locational information is measured, abnormal locational data may be filtered out, and accuracy of the locational information of the sports player may be improved.

Also, according to one embodiment of the present disclosure, by determining whether a target device is moving based on an inertial sensor and determining validity of the information on the location of a sports player based on the determination, the GPS ghosting issue, where displacement is erroneously measured from a stationary device, may be addressed.

Also, according to one embodiment of the present disclosure, by performing preprocessing utilizing positioning information preceding the target time point, real-time locational information with improved accuracy may be acquired.

Also, according to one embodiment of the present disclosure, by appropriately designing a data processing procedure for post-analysis and/or real-time analysis, consistency may be ensured between the information provided through post-event analysis and real-time analysis.

For the convenience of description, the present disclosure may describe the global positioning mechanism such as GPS as a procedure for acquiring sensor-based locational information; however, it should be noted that the description is given merely for the illustrative purpose, and the locational information of a player according to embodiments of the present disclosure is not limited to the specific positioning mechanism.

### Terms

Specific technical terms may be used for the present disclosure; in what follows, terms used herein are described to establish definitional support for the terms.

The following is a summary of the preferred definitions of several terms used in the present disclosure. The definitions provided below are merely exemplary and are neither exhaustive nor restrictive.

The term “image-based locational information” may refer to information on the position of an object determined using an image containing the object. The image-based locational information may include information on the position of at least one object determined from a captured image of one or more objects. For example, the image-based locational information may include, but is not limited to, information on the position of each player determined by analyzing a video of a team sport game in which a plurality of players participated and should be interpreted in a comprehensive sense to include locational information acquired from captured images of any type of object.

The term “sensor-based locational information” may refer to information on the position of an object determined using a signal from a sensor corresponding to the object. The sensor-based locational information may include information on the position or displacement of at least one object determined based on signals from sensors corresponding to each of one or more objects. For example, the sensor-based locational information may include, but is not limited to, locational information acquired through positioning solutions utilizing the Global Navigation Satellite System (GNSS) such as GPS or utilizing a Local Positioning System (LPS) and should be interpreted in a comprehensive sense to include locational information of an object acquired through signals from a sensor corresponding to the specific object.

For example, an acceleration-related signal may be measured from an inertial measurement unit (IMU) corresponding to an object, and by integrating the acceleration measurement value, velocity information may be obtained; furthermore, by integrating the velocity information again, displacement may be acquired, thereby implementing a method of measuring the movement path of the corresponding object. The displacement information of an object should also be interpreted as being included in the sensor-based locational information.

The term “positioning state characteristic value” may refer to a quantified value representing the positioning state at the time of positioning an object, such as a sports player. For example, the positioning state characteristic value may include, but is not limited to, the number of satellites used during positioning, the strength of received signals, or the positioning mode in which the positioning is performed; and should be broadly interpreted such that at least one of arbitrary conditions indicating the positioning state, such as the surrounding environment or characteristics at the time of positioning and measurement values, is included in the positioning state characteristic value.

The term “processed locational information” may refer to the locational information that has been processed to minimize measurement errors in determining locational information at a target time point and to minimize the effect due to the occurrence of an error with improved accuracy by performing data processing based not only on the measurement value at the target time point but also on the measurement values at other time points. Here, the term “processing” should be broadly interpreted to include any computational procedure that utilizes an arbitrary distribution or mechanism to determine the locational information at the target time point.

### System

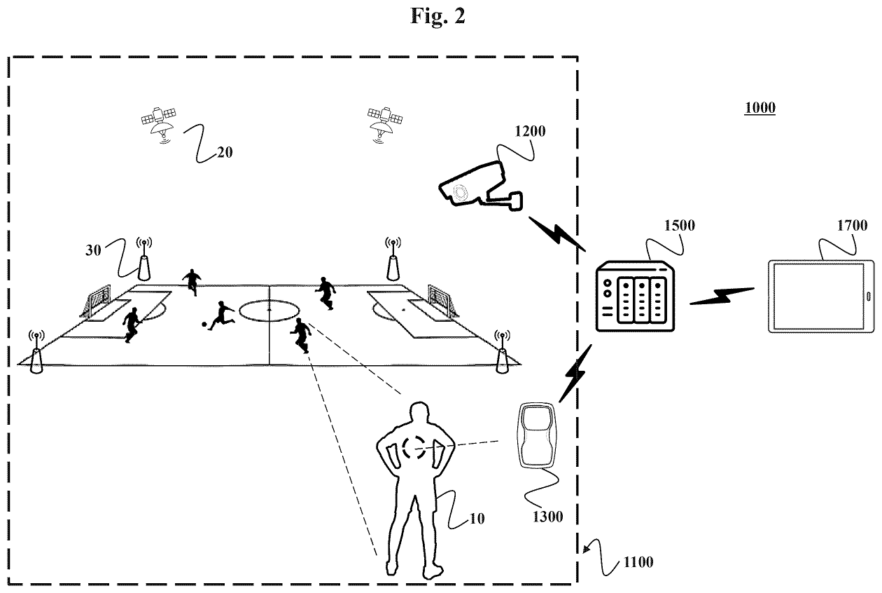

FIG. 2 illustrates an exemplary system in which a method for collecting information on the location of a sports player in real-time according to one embodiment of the present disclosure may be performed. In what follows, with reference to FIG. 2, a system 1000 for collecting information on the location of a sports player according to an embodiment of the present disclosure will be described. However, the procedure for collecting information on the location of a sports player according to the embodiments of the present disclosure should not be interpreted as being performed only by the system configuration shown in FIG. 2; it should be understood that any hardware configurations for collecting information on the location of a sports player in real-time and processing the collected information and a combination of the configurations may be adopted for implementing the procedure for collecting real-time information on the location of a sports player according to the embodiments of the present disclosure.

As shown in FIG. 2, the system 1000 may comprise a sensing platform 1100 and a server 1500. According to one aspect, the system 1000 may further include a terminal 1700.

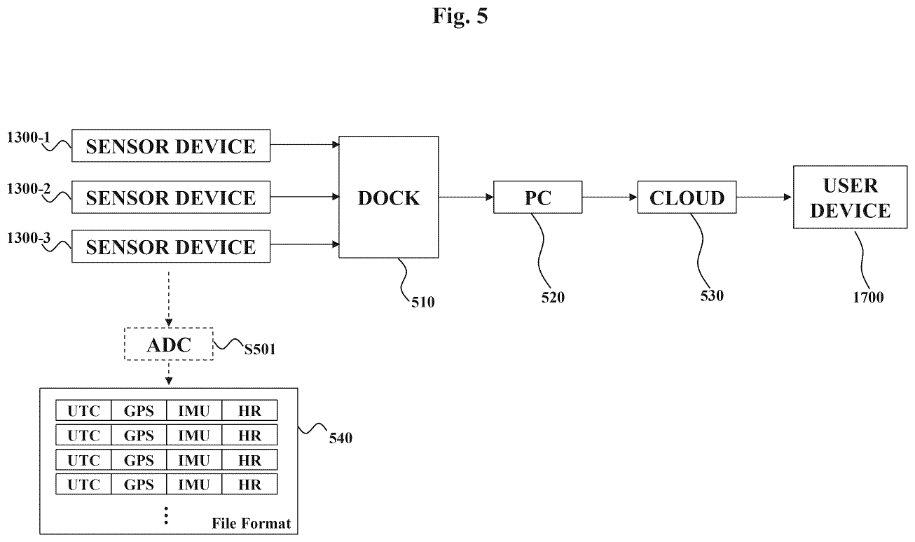

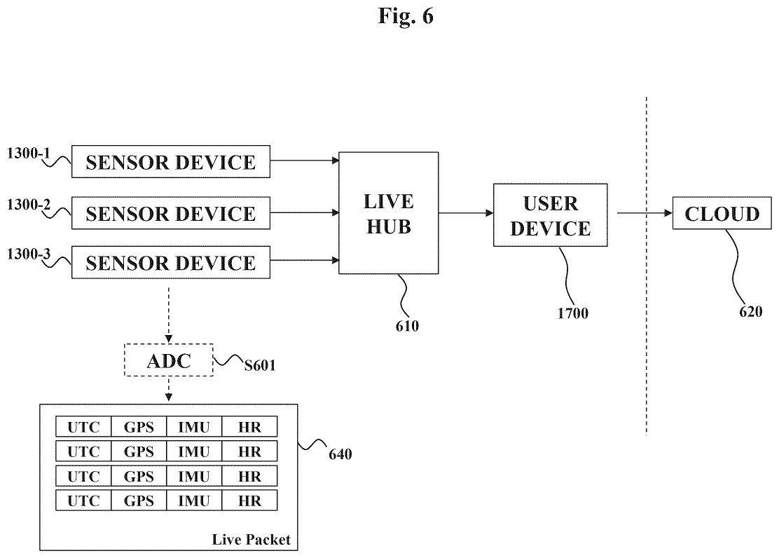

The system 1000 may detect information on an object, for example, a player 10, over a target time interval through the sensing platform 1100 and determine information on the player from the detected information through the server 1500. Also, the system may display trajectory information of the determined object through the terminal 1700. FIG. 2 illustrates the server 1500 and the terminal 1700 as separate entities; however, it should be noted that the embodiments of the present disclosure are not limited thereto. For example, a tablet PC integrating the server 1500 and the terminal 1700 may be used to provide player information in real-time and simultaneously display player information along with a sports video. Furthermore, although not shown in FIG. 2, the system may also be configured such that a relay device, such as a live hub, is further provided before the server 1500 to receive data for collecting information from the sensing platform 1100, information from a plurality of devices included in the sensing platform are received by the relay device, and the received information is again transmitted to the server 1500 or the terminal 1700. In other words, depending on whether post-analysis or real-time analysis is performed, the configuration of the system 1000 may be partially modified, which will be described in more detail with reference to FIGS. 5 to 6 in the following part of the present disclosure.

In what follows, first, exemplary components of a system for collecting information on the location of a sports player according to an embodiment of the present disclosure will be described.

### Sensing Platform

The sensing platform 1100 may detect various types of information on an object 10, for example, a player. For example, the sensing platform 1100 may perform positioning of the object 10 or detect the movement of the object 10.

For example, the sensing platform 1100 may detect kinematic information related to the object 10. Kinematic information refers to information regarding the position, orientation, and movement of the object 10, which may include at least one of locational information, orientational information, and movement information; movement information may include at least one of velocity, acceleration, jerk, angular velocity, angular acceleration, angular jerk, their magnitudes (e.g., speed in the case of velocity) and their directions (e.g., movement direction in the case of velocity).

The results of the positioning performed by the sensing platform 1100 on the object 10 may be provided as locational information; alternatively, the object's position may be determined by processing at least one or a combination of the kinematic information and then provided as locational information.

The sensing platform 1100 may be implemented in various forms to detect the various types of information. For example, the sensing platform 1100 may be implemented as a sensor-based platform utilizing sensor devices 1300, which are provided to correspond to each object 10 and transmit signals based on measurement results.

### Sensor-Based Platform

In what follows, a sensor-based sensing platform will be described.

The sensor-based sensing platform may include a sensor device 1300. The sensing platform may acquire activity information regarding an object 10 corresponding to the sensor device 1300 using the sensor embedded in the sensor device 1300. In one aspect, the sensor device 1300 may be implemented as an attachable device affixed to each object 10; however, the sensor device is not limited to the specific implementation and may include any type of device configured to perform sensing of the corresponding object.

The sensor device 1300 according to one embodiment may be attached to the object 10 and utilized to detect activity information of the object 10. For example, the sensor device 1300 may include a Global Positioning System (GPS) sensor and be used for positioning the object 10 to which the sensor device 1300 is attached.

One or more sensor devices 1300 may be attached to one object 10. In particular, when it is difficult for a single sensor device 1300 to obtain all the information required by the sensing platform, a plurality of sensor devices 1300 may need to be attached to one object 10. For example, an attachable device including a GPS sensor and an Inertial Measurement Unit (IMU) sensor and another attachable device including a heart rate sensor may be attached to the torso and wrist of the object 10, respectively, while the device attached to the torso may be configured to sense the position and movements of the object 10.

For example, the sensor-based sensing platform may acquire kinematic information using the sensor device 1300.

In what follows, several examples of acquiring kinematic information by the sensor-based sensing platform will be described.

The sensing platform may acquire locational information using a positioning module of the sensor device 1300.

For example, the sensor device 1300 may include a global positioning module (also referred to as a satellite positioning module or a Global Navigation Satellite System (GNSS) module), and the sensing platform may measure the location of the object 10 by performing global positioning using the module. Specifically, the sensing platform may perform global positioning for the object 10 by receiving satellite signals from navigation satellites 20 through the GNSS module and calculating a global position (e.g., latitude and longitude) using a triangulation method from the received satellite signals. Meanwhile, the sensing platform may include a base station to perform Real-Time Kinematic (RTK) positioning for more accurate positioning. The sensing platform may utilize the global position directly as activity information or process the global position into a local position defined in the pitch coordinate system for the sports field and use the local position as activity information. Here, the pitch coordinate system may be a two-dimensional plane coordinate system with the length and width directions of the field as axes and a specific point on or around the sports field (e.g., one of the corners or the center of the sports field) as the origin. Meanwhile, it should be noted that all location-related information processed below may be handled in an unlimited manner according to the pitch coordinate system.

In another example, the sensor device 1300 may include a local positioning module, and the sensing platform may measure the location of the object 10 by performing local positioning using a local positioning sensor network that includes the sensor device 1300. The local positioning sensor network consists of a moving tag node attached to a positioning target object and anchor nodes 30 that are fixedly installed within the positioning area; positioning may be performed using Local Positioning System (LPS) signals transmitted and received between the tag node and the anchor nodes. The sensing platform may perform local positioning using transmission and reception results of LPS signals between the sensor device 1300, which includes a local positioning module and operates as a tag node by being attached to the positioning target object 10, and anchor nodes 30, which are fixedly installed on or around the sports field.

The sensing platform may obtain movement information and/or directional information using the motion sensing module of the sensor device 1300.

For example, the sensor device 1300 may include an IMU sensor (or an Attitude and Heading Reference System (AHRS) sensor), and the sensing platform may acquire movement information and/or directional information of the object 10 or a body part of the object 10 by utilizing acceleration, angular velocity, and heading angle detected by the IMU sensor. If the sensor device 1300 is attached to the torso of the object 10, movement information related to the positional displacement of the object 10 may be obtained; if the sensor device 1300 is attached to the arm or leg of the object 10, movement information of the arm or leg of the object 10 may be acquired.

Meanwhile, the sensing platform may calculate other types of kinematic information using the measured kinematic information. For example, the sensing platform may calculate velocity based on the global position measured continuously from the GPS module and the GPS module's sampling interval. Since the calculation of kinematic information may be performed through simple mathematical operations, such as vector operations or differentiation and integration with respect to the time, a detailed description thereof is omitted. Here, the calculation of kinematic information may be performed internally within the sensor device 1300, or the calculation may be performed in the server 1500 or the user terminal 1700, which receives information from the sensor device 1300; within the sensor device 1300, the sensing module may directly perform the calculation, or a controller of the sensor device 1300 may perform the calculation based on the detection results from the sensing module.

### Sensor Device

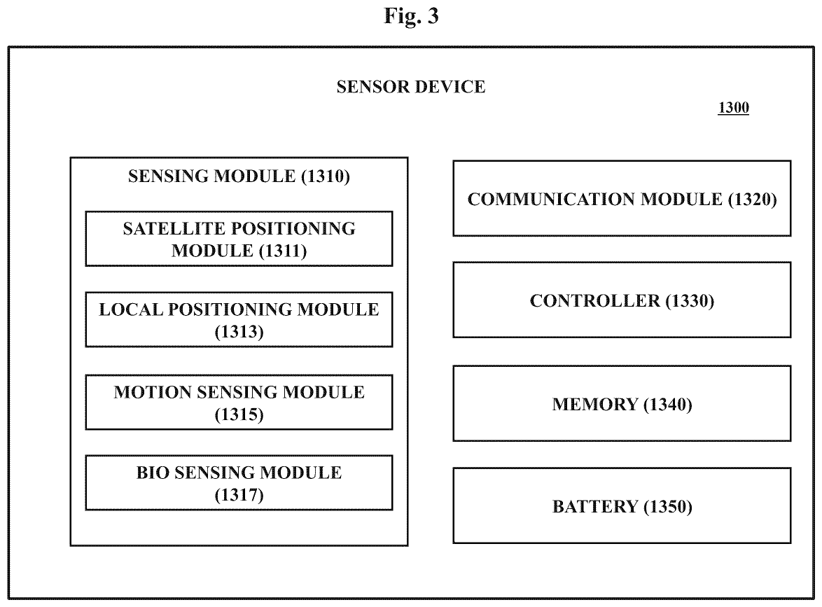

FIG. 3 is a block diagram of a sensor device that may be used for collecting information on the location of a sports player according to one embodiment of the present disclosure.

As illustrated in FIG. 3, the sensor device 1300 according to one embodiment of the present disclosure may include a sensing module 1310, a communication module 1320, a controller 1330, a memory 1340, and a battery 1350.

The sensing module 1310 may detect various signals to acquire activity information. The sensing module may be a positioning module or a motion sensing module.

The positioning module may be a satellite positioning module 1311 or a local positioning module 1313. The satellite positioning module 1311 may perform positioning using a navigational satellite system, namely GNSS. Here, GNSS may include a Global Positioning System (GPS), GLONASS, BeiDou, and Galileo. Specifically, the global positioning module may include a satellite antenna that receives satellite signals and a positioning processor that performs positioning using the received satellite signals. For example, the satellite positioning module may be a GPS module including a GPS antenna that receives GPS signals and a GPS processor that performs positioning using the GPS signals. At this time, the sensor device 1300 may function as a GPS receiver, receiving GPS signals from satellites to obtain latitude, longitude, altitude, speed, heading, Dilution of Precision (DOP), and time.

The local positioning module 1313 may perform positioning in cooperation with a sensor network. The sensor device 1300, including a local positioning module, may function as a tag node in a local positioning sensor network and transmit and receive LPS signals to and from surrounding anchor nodes, where positioning may be performed based on the transmission and reception results of the LPS signals. For example, the sensor device 1300 may transmit LPS signals as a transmitter in a sensor network for local positioning, and anchor nodes may receive the LPS signals; alternatively, anchor nodes may transmit LPS signals, and the sensor device 1300, operating as a receiver in the sensor network for local positioning, may receive LPS signals. At this time, the LPS signals may be periodically broadcast according to communication methods such as Ultra-Wide Band (UWB), Bluetooth, Wi-Fi, or RFID, and the LPS signals may include timestamps or device identifiers. Position estimation may be performed based on the measurement results from the transmission and reception of LPS signals, and methods such as Received Signal Strength (RSS), Time-of-Arrival (ToA), Time Difference-of-Arrival (TDoA), Angle-of-Arrival (AOA), triangulation, and hyperbolic triangulation may be used for position estimation. Position estimation may be performed by a master of the sensor network, and any of the tag node, anchor nodes, or server may function as the master of the sensor network. If the sensing platform further includes an RTK base station, the master's position estimation function may be embedded in the base station.

The motion sensing module 1315 may also be referred to as a kinematic sensing module and may detect movement and/or pose. Here, the motion sensing module 1315 may include an IMU module or an AHRS module; the IMU module and the AHRS module may include an accelerometer and a gyroscope, and optionally a magnetometer and may measure movement and pose from on the sensor detection results. According to one aspect, the inertial sensor may provide information on whether a movement of an object exists together with the information on changes in the movement and/or pose of the object. For example, a movement flag may be provided as a field with a minimal number of bits, indicating whether movement has been detected by the inertial sensor or not.

The bio-sensing module 1317 may be configured to collect information on various biometric signals of an object associated with the sensor device 1300. For example, the bio-sensing module may include at least one of a heart rate sensor and an electrocardiogram (ECG) sensor, but is not limited thereto.

Meanwhile, the sensing module does not necessarily have to be equipped in every sensor device 1300, and a plurality of identical sensing modules may be included in a single sensor device 1300; moreover, different sensor devices 1300 may have different sensing modules. For example, the sensing platform may include a GPS sensor and an Inertial Measurement Unit (IMU) sensor to acquire locational and movement information on the object 10 and include two different sensor devices 1300: one attached to the torso of object 10 and another attached to the wrist of object 10.

The sensor device 1300 may transmit and receive data with an external device such as the server 1500 or the user terminal 1700; or another sensor device 1300 via the communication module 1320. The communication module 1320 may perform wired and/or wireless communication. The sensor device 1300 may use a wireless communication module that performs communication via a mobile communication network (e.g., LTE, 5G), Wi-Fi, Bluetooth, Zigbee, or other various wireless communication specifications to exchange data with external devices. For example, the wireless communication module 1320 may enable the sensor device 1300 to transmit data acquired via the sensing module 1310 to server 1500 in real-time for monitoring of the object 10 using activity information by the system; also, if a plurality of sensor devices 1300 are attached to a single object 10, data may be exchanged among the sensor devices. Also, the sensor device 1300 may also use a wired communication module that supports Universal Serial Bus (USB) communication or wired Local Area Network (LAN) communication to exchange data with external devices. For example, the wired communication module may transfer data collected by the sensor device 1300 in bulk to the server 1500 or to a docking station that handles charging and/or data management of the sensor device 1300.

The controller 1330 may control the overall operation of the sensor device 1300. The controller 1330 may be implemented in hardware, software, or a combination thereof. From a hardware perspective, the controller 1330 may be provided in various forms capable of performing computations or data processing, such as an electronic circuit, an integrated circuit (IC), a microchip, or a processor. Also, since the physical configuration of the controller 1330 is not necessarily limited to a single physical entity, the controller 1330 may be provided as a single processor that handles all processing within the sensor device 1300, as a plurality of processors that each perform different functions, or in a form integrated with other constituting elements of the sensor device 1300. For example, the controller 1330 may be provided in a form including a main processor that manages and controls the overall operations of a GPS processor that processes GPS signals for positioning, an IMU processor that performs various calculations using the sensing results from the IMU module, and the sensor device 1300.

The memory 1340 may store various data related to the operation of the sensor device 1300. For example, the memory 1340 may store firmware that governs the operation of the sensor device 1300 or detection results from the sensors of the sensor device 1300. The memory 1340 may be provided in various forms of volatile or non-volatile memory.

The battery 1350 may supply the power necessary to operate the sensor device 1300. The battery 1350 may be provided as either a built-in or a detachable type and may be charged by receiving power from an external power source.

### Video-Based Platform

In what follows, a video-based platform will be described. The video-based platform may include, for example, a camera 1200.

The camera 1200 may be disposed in or around the sports field to capture images of the field or objects 10 moving in the field for applications in sports analysis. The camera 1200 may be installed in a semi-permanent manner (e.g., attached to an accessory facility of the field), temporarily (e.g., mounted on a mobile pole), or handheld by an operator of the camera. The sports video captured by the camera 1200 may include a tactical view, a broadcasting view, or a player-focused view. The tactical view is generally used for sports tactical analysis, capturing most objects 10 in the frame to analyze team tactics, and the horizontal axis of the tactical view may correspond to the length or width of the field. The broadcasting view is mainly used for sports broadcasting, typically featuring a narrower field of view than the tactical view, and the player-focused view follows a specific object 10 and is primarily used for analyzing individual performance of the object 10. The camera 1200 is not necessarily limited to a fixed viewing angle; adjustments of the viewing direction and zoom settings may be performed manually or automatically.

According to one aspect of the present disclosure, the video-based platform may include one or more cameras. A plurality of cameras may be provided in a multi-camera arrangement at a single spot to capture a panoramic video or may be distributed across multi-spots, or a combination of both configurations may be used.

The video-based platform may be configured to acquire various types of sports videos through the camera 1200.

Meanwhile, according to one aspect, image-based locational information may be acquired separately from sensor-based locational information. For example, the sensing platform may analyze the video captured by the camera 1200 to extract activity information. For example, the sensing platform may perform object recognition on the image to detect a object 10, extract the position of the object 10 in the image (e.g., pixel coordinates), and project the position in the image onto the ground using the pose information of the camera 1200 to obtain the locational information of the object 10. Deep learning algorithms may be employed for video processing, such as object detection. More specifically, various deep learning algorithms for object detection, ranging from Region-based Convolutional Neural Network (RCNN) to You-Only-Look-Once (YOLO), may be utilized for object detection (e.g., detection of the object 10), while top-view transformation using camera parameters (e.g., installation position, capture pose) may be used for coordinate conversion. For example, the server 1500 may acquire a sports video from the camera 1200 disposed to capture a tactical view, obtain bounding boxes for sports objects such as a ball or the object 10 from the sports video through an artificial neural network model that performs object detection, determine a representative pixel (e.g., the lower center of the bounding box) for each detected object, and acquire locational data for the sports objects by performing top-view transformation using a coordinate conversion metric between the reference coordinate system and the pixel coordinate system defined in the sports video generated based on the camera parameters with respect to the representative pixel determined. Here, object detection using an artificial neural network may be replaced by object segmentation. Accordingly, the server 1500 may obtain locational data for sports objects within the sports video captured by the camera 1200 through video analysis.

As described above, the sensing platform 1100 may further include a base station for RTK correction and anchor nodes for constructing a local positioning sensor network selectively as needed.

Also, part of the various computations performed in the sensing platform 1100 may be processed by the processor or controller embedded in the sensor device 1300, while other parts may be handled by the server 1500 or user terminal 1700. For example, object detection in the video may be processed by the server 1500; position estimation based on the transmission and reception results of LPS signals between nodes in the local positioning sensor network may be handled by the server 1500; and various processing tasks related to video analysis may also be performed by the server 1500. Therefore, in this case, the server 1500 may be understood as being included in the sensing platform 1100.

### Server

The server 1500 may be configured to receive locational information from the sensing platform 1100 or operate in conjunction with the sensing platform 1100 to acquire locational information and use the acquired locational information to track the trajectory of an object.

According to one aspect, the server 1500 may be provided as a local server located near the sports field and/or a web server connected via the internet. Also, the server 1500 does not necessarily have to be implemented as a single entity; for example, the web server may be configured to include a main server that handles computations and a data server that stores various types of data. Meanwhile, the local server may be provided as a device operating independently to perform only the functions inherent to the server; however, the local server may also be provided as a multifunctional device integrated with other constituting elements of a sports workload information provision system. For example, the server may be provided in the form of a docking station that serves as a container for accommodating, storing, and managing sensor devices 1300. Here, the docking station may include a docking space to accommodate the sensor device 1300 and an internal space for storing multiple sensor devices 1300 when they are not in use. Furthermore, the docking station may offer various convenience functions necessary for using the sensor devices 1300 in addition to merely storing them. For example, the docking station may perform the functions such as charging, battery status indication, firmware updates, and data collection for the sensor devices 1300.

Also, as described above, the server may be integrated with the terminal 1700 and, for example, may be a mobile computing device such as a tablet PC.

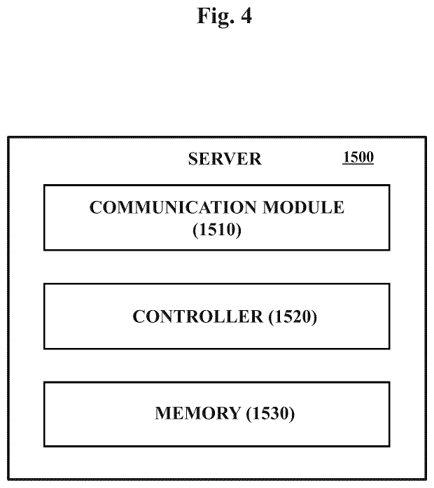

FIG. 4 is a block diagram of a server according to one embodiment of the present disclosure.

The server 1500 may include a communication module 1510, a controller 1520, and a memory 1530.

The communication module 1510 may perform data transmission and reception between the server 1500 and other constituting elements of the object tracking system or external devices. For example, the server 1500 may collect data from the sensor device 1300 via the communication module 1510, receive a video from the camera 1200, or transmit various types of information to the terminal 1700 through the web or through wired or wireless communication.

The controller 1520 may control the overall operation of the server 1500. In the same way as the controller of the sensor device 1300, the controller 1520 of the server may be implemented in hardware, software, or a combination thereof; from a hardware perspective, the controller may be provided in various forms capable of performing computations or data processing, such as an electronic circuit, an integrated circuit (IC), a microchip, or a processor; also, the physical configuration of the controller is not necessarily limited to a single physical entity. Meanwhile, the specific operations performed by the server 1500 will be described later, and unless otherwise specified, it should be understood that the methods or operations according to the embodiments of the present disclosure described later are performed by the controller 1520 of the server but are not necessarily limited to being performed by the controller 1520 of the server.

However, as described in the present disclosure, the embodiments of the present disclosure are not necessarily performed solely by the controller 1520 of the server; it should be understood that the embodiments of the present disclosure may, for example, be performed by any computing processor, such as the controller 1330 of the sensor device 1300, or at least part of the process may be performed by the server, while at least different part of the process may be performed by a different processor. In particular, when information on the location of a sports player is collected in real-time according to the embodiments of this disclosure, more procedures may be directly performed by the sensor device 1300 or its controller 1330 compared to the cases where only post-event analysis is considered.

### Terminal

The terminal (or terminal device or user device) 1700 may function as a user interface that provides various data or information collected or generated by the system to the user or receives user input from the user. The terminal 1700 may be a smart device such as a smart phone or a tablet; a personal computer such as a laptop or a desktop; or an electronic device having an input interface for receiving user input and an output interface such as a display. In particular, in performing real-time sports analysis according to the embodiments of the present disclosure, the user device 1700 may be configured to directly perform metric calculations based on collected information on the location of a sports player and provide sports analysis results to the user.

### System Structure for Post-Analysis

FIG. 5 is a block diagram illustrating the structure of an exemplary system for post-analysis of a sports event. In what follows, the structure of an exemplary system for performing post-analysis of a sports event after the sports event is over will be described in more detail with reference to FIG. 5.

As illustrated in FIG. 5, according to an aspect of the present disclosure, the system may include a plurality of sensor devices 1300-1, 1300-2, 1300-3 corresponding to a plurality of sports players. Each sensor device may be configured to collect kinematic information and/or biometric signal information related to the corresponding sports player. Here, if post-event analysis is to be performed, the sensing information from the sensor devices may be collectively transmitted to a processing device, such as a docking station 510, after the sports event is ended. Accordingly, the sensing information acquired by the sensor devices during the sports event may be selectively processed through analog-to-digital conversion S501 and stored in a storage means included in the corresponding sensor device. The sensing information stored in this manner may be in a specific file format 540, as illustrated in FIG. 5. The sensing information may correspond to messages collected according to time and devices, where each message contains time information based on a standard reference time, such as the Coordinated Universal Time (UTC), positioning information such as GPS values, motion information such as IMU sensing values, and biometric information such as HR values.

Once a sports event is ended, a plurality of sensor devices may be connected to an interface device, such as a docking station 510, which is configured to enable charging of the devices and/or data transmission and reception to and from the devices; for example, sensing information stored in a specific file format 540 may be transmitted to a computing device, such as the personal computer 520, via the docking station 510. The information exchange between the docking station 510 and the personal computer 520 may be conducted through a wired connection, including a USB or serial port; however, the information exchange is not limited to the specific means above, and any wireless communication architecture, including Bluetooth, Wi-Fi, or cellular communication, may also be employed.

The sensing information transmitted to the personal computer may be further transmitted through a network to, for example, a cloud service 520 or a dedicated server, enabling post-event analysis of a sports event based on the sensing information. The sports analysis results may be sent to the user terminal 1700 based on wired or wireless communication upon the user's request, allowing the user to check the desired analysis results.

### System Structure for Real-Time Analysis

FIG. 6 illustrates the structure of an exemplary system for real-time analysis of a sports event. In what follows, the structure of an exemplary system for analyzing a sports event or training session in real-time while the sports event or training session is being performed will be described in more detail with reference to FIG. 6.

As illustrated in FIG. 6, real-time analysis of a sports event or training session may be performed by the user terminal 1700; however, it is not necessarily limited to being performed by the user terminal. Real-time analysis may be performed by any computing device equipped with a processor; in what follows, it is assumed that real-time analysis is performed by a user terminal, such as a tablet PC, which is easily portable to a sports event site; however, it is not necessarily limited to being performed by the specific device.

According to one aspect of the present disclosure, before performing real-time sports analysis, the user terminal 1700 may first connect to a remote entity, such as a cloud server 620. The cloud server 620 may store fundamental information necessary for sports analysis, and the user terminal 1700 may retrieve the basic information corresponding to the event from the cloud. The basic information may include configuration values for real-time analysis. For example, the configuration values may include the identification numbers of sensor devices used for sports analysis and the corresponding player matching information. Also, the configuration values may pertain to the settings for a target team for sports analysis. The reference values for metric calculations in sports analysis may vary depending on the team or individual being monitored for sports analysis. For example, in sports event analysis, the number or frequency of sprints is a critical factor, and each team may have different criteria for sprints. For example, a particular team may define a sprint as maintaining a speed of 25.4 km/h or higher for 0.5 seconds or longer, whereas another team may set the speed criterion at 20, 25, or 30 km/h; in other words, different analysis criteria may be applied to individual teams. Before performing real-time analysis, the user terminal 1700 may be configured to switch its connection state to the cloud 620 to the online mode and receive basic analysis information, such as the information related to sensor devices or criteria for sports analysis. After receiving the basic analysis information, the user terminal 1700 may be configured to perform real-time analysis while performing information exchange with elements within the sports field, without maintaining the connection state to the cloud 620.

As illustrated in FIG. 6, according to one aspect of the present disclosure, the system may include a plurality of sensor devices 1300-1, 1300-2, 1300-3 corresponding to a plurality of sports players. Each sensor device may be configured to collect kinematic information and/or biometric signal information related to the corresponding sports player.

Here, if real-time sports analysis is to be performed, the sensing information from the sensor devices may be transmitted to the user terminal 1700 during the sports event. Accordingly, the sensing information acquired by the sensor devices during the sports event may be selectively processed through analog-to-digital conversion S601 and processed into live packets for transmission to the user terminal 1700. The sensing information included in the live packets generated as described above may have a packet structure 640 having a specific format, as illustrated in FIG. 6. The sensing information may correspond to messages collected according to time and devices, where each message contains time information based on a standard reference time, such as the Coordinated Universal Time (UTC), positioning information such as GPS values, motion information such as IMU sensing values, and biometric information such as HR values. The transmission period of the live packets sent from the sensor devices to the user terminal 1700 may be, for example, 2 Hz but is not limited to the specific period. Furthermore, the number of measurement time points of sensing information included in a single packet may be determined by considering at least one of the transmission period of the live packets and/or the sensing period of the sensor devices but is not limited to the specific example above.

Also, the number of sensing time points included in a single packet may also vary depending on the information exchange policy. For example, according to embodiments of the present disclosure, the sensor devices may be configured to transmit information using the UDP protocol. Compared to the TCP/IP protocol, which determines transmission success based on whether an ACK is received for the transmitted information, the UDP protocol does not require a separate ACK procedure, thereby providing significant advantages in terms of battery efficiency of the sensor devices.

In this regard, in an environment for performing real-time sports analysis, various obstructing factors exist, particularly when performing sensor-based positioning using GPS, as described above. For example, as described with reference to FIG. 1, obstructing factors may include issues such as satellite signals being reflected by stadium structures, the signal coverage of the sensor devices failing to encompass the entire stadium, and signal interference caused by wireless communication devices carried by numerous spectators. To address these issues, according to embodiments of the present disclosure, the signal strength of the sensor devices may be set as high as possible while satisfying actual legal regulations. Accordingly, the signal coverage of the sensor devices may be allowed to encompass the entire stadium, and a robust radio transmission and reception environment may be established to mitigate signal interference caused by spectators or sports facilities. This minimizes shadow areas and transmission failures in data transmission and reception for sports analysis, thereby ensuring that no data loss occurs.

In this regard, increasing the signal strength may introduce disadvantages in terms of battery efficiency for the sensor devices; however, according to an embodiment of the present disclosure, the battery efficiency issue may be addressed by adopting the UDP protocol, which obviates repeated signal transmissions for ACK. Nevertheless, the possibility that data measured at a specific time point may not be transmitted to the user terminal 1700 should be considered; according to an embodiment of the present disclosure, the data loss issue may be addressed by making each live packet transmitted from the sensor devices to the user terminal 1700 include not only the measurement data acquired immediately before transmission time point but also all measurement data recorded over a predetermined time period. For example, each live packet may include a one minute-long history; if the sampling rate of the sensor device is 10 Hz, measurement information at 600 time points may be transmitted for each transmission cycle. The transmission period of live packets may be set, for example, to transmit the packet twice per second; accordingly, as long as the user terminal successfully receives information from a specific sensor device at least once within a one-minute period, all data from that sensor device may be acquired without any information loss. Consequently, even when the UDP protocol is employed, the data loss issue may be resolved.

As shown in FIG. 6, a relay device for data transmission, such as a live hub 610, may be provided between the sensor devices and the user terminal 1700. In other words, the live hub 610 may be configured to receive information from the sensor devices, amplify the received information, and transmit the amplified information to the user terminal 1700. Accordingly, reliability of data transmission and reception may be further enhanced.

The user terminal 1700 may perform real-time analysis of a sports event or training session based on the received information. In other words, the user terminal 1700 may perform metric calculations while simultaneously providing the analysis results to the user.

After the sports event is ended, the user terminal may switch its connection state to the cloud 620 back to the online mode and transmit at least a portion of the collected information and/or analysis results to the cloud 620.

### Real-Time Player Information Collection

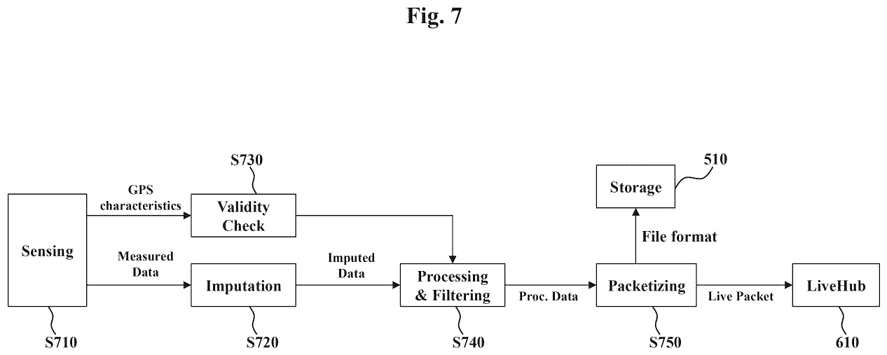

FIG. 7 illustrates a procedure for collecting information on the location of a sports player in real-time according to one embodiment of the present disclosure. As shown in FIG. 7, to collect information on the location of a sports player, the information related to the sports player may first be sensed S710. The information sensing may be performed by the sensor devices 1300 shown in FIGS. 2 to 6.

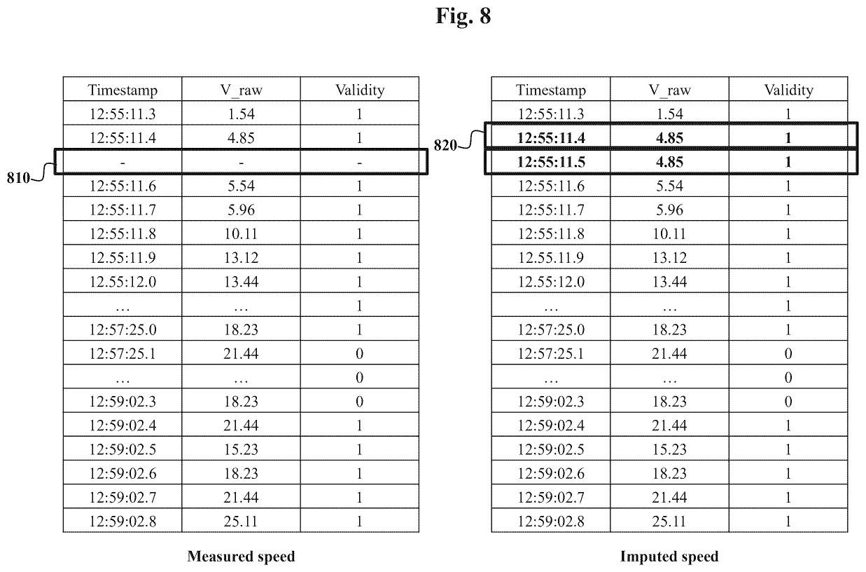

According to one aspect of the present disclosure, as illustrated in FIG. 7, missing value imputation S720 may be performed on the data measured by the sensor device 1300. In this regard, FIG. 8 illustrates missing value imputation according to one embodiment of the present disclosure. As illustrated in FIG. 8, according to embodiments of the present disclosure, locational information of a player may be collected at predetermined time intervals over a plurality of time points during a target time period, which corresponds to the duration of the sports event.

As shown in FIG. 8, the predetermined time interval may be, for example, 0.1 seconds, as indicated in the timestamp field. In other words, the expected sampling rate of the information may be 10 Hz. The measured data may correspond to speed at measurement intervals, as illustrated in FIG. 8, where the speed value of the target player is measured at each time point.

In this regard, while the expected time interval between a plurality of data points is 0.1 seconds, the actual sampling rate of the positioning sensor embedded in the sensor device may not precisely match 10 Hz, such as 9.97 Hz, which may result in discrepancies in data sensing. According to one aspect of the present disclosure, for missing data 810 occurred at a specific time point, which is a first time point (e.g., 12:55:11.5 in FIG. 8) due to the discrepancy between the sampling period of the positioning sensor and the expected predetermined time interval for the locational information of the player, the missing locational information of the player at the first time point may be replaced with the locational information of the player at a time point 820 (e.g., 12:55:11.4) before the first time point based on the predetermined time interval. Consequently, even if missing values occur due to the sampling rate of the sensor device at a particular time point among a plurality of time points according to predetermined time intervals, the subsequent data processing procedure may ensure that no missing data occurs at any time point. In other words, as illustrated on the right side of FIG. 8, in the case of using imputed speed values, the sensing values may be made available for all time points of a plurality of time points according to the predetermined time intervals.

Referring back to FIG. 7, the validation procedure S730 may be performed on the data measured by the sensor device 1300, as illustrated in FIG. 7. As described above, in the embodiments of the present disclosure, GPS may be used as an exemplary positioning mechanism. In this case, abnormal measurement values may be included in the sensing results due to various factors. If analysis is performed without addressing the abnormal measurement values, significant errors may be introduced into the analysis results.

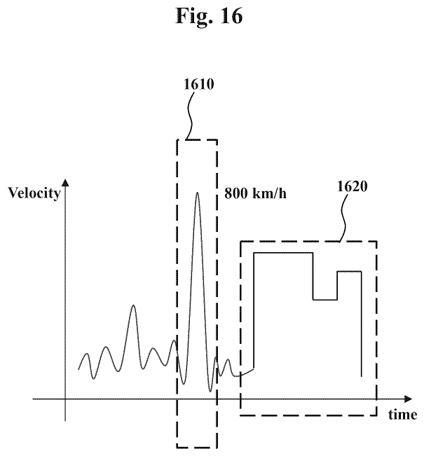

In this regard, FIG. 16 illustrates an example of an abnormal measurement value related to positioning. Abnormal measurement values in the positioning results may appear in various forms; for example, as shown in FIG. 16, abnormal values may include cases where momentarily excessive or abnormally low values appear 1610 or cases where the measurement values fluctuate abnormally, such as a case where the measurement values change stepwise as a predetermine amount of time passes 1620.

Abnormal measurement values may show physically infeasible results; for instance, as illustrated in FIG. 16, the instantaneous speed of a sports player may be measured as 800 km/h, which is an unrealistic value. Such abnormal values may arise from at least one of the following factors: reflective characteristics of steel structures used in the stadium, the GPS triangulation and time-of-flight (ToF)-based measurement mechanisms, and the velocity calculation mechanism using the phase shift-based Doppler effect; however, factors that may cause abnormal measurements are not necessarily limited to the specific cases above.

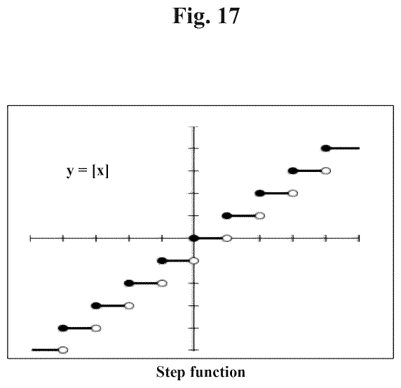

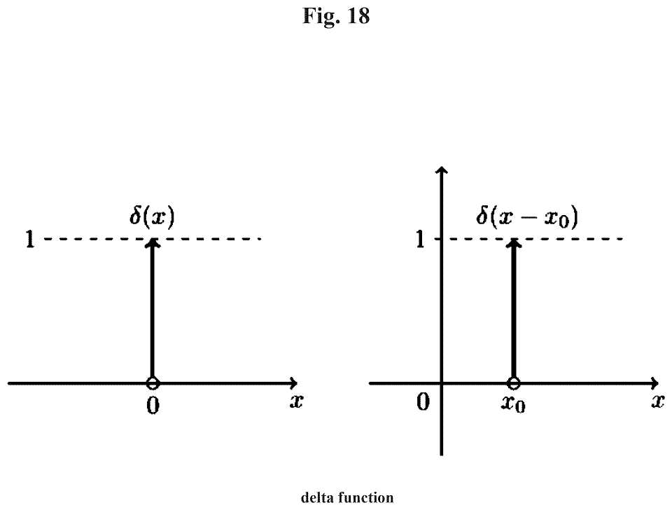

In the conventional sports analysis utilizing post-event analysis, processing of abnormal measurement values is performed on the already acquired time-series data after the sports event is ended. For example, FIG. 17 illustrates a step function. FIG. 18 illustrates a delta function. In other words, as shown in FIG. 17 or FIG. 18, step functions and delta functions have been effectively utilized to detect abnormal measurement values, such as those illustrated in FIG. 16. However, since data beyond the current time point is not available when sports analysis is performed in real-time as in the embodiments of the present disclosure, various procedures used in the conventional post-event analysis may not be fully applied.

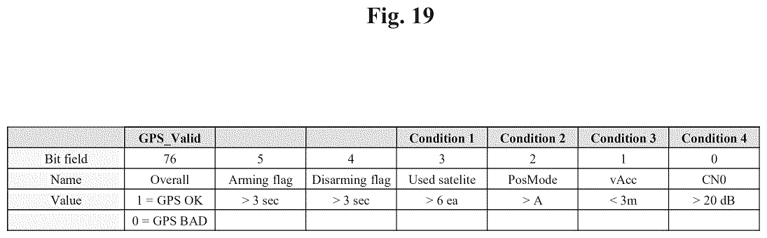

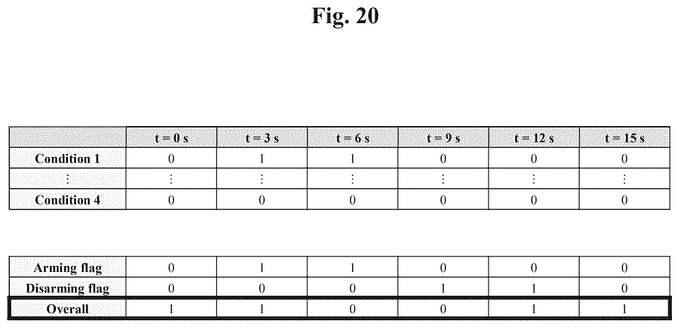

According to one aspect of the present disclosure, as illustrated in FIG. 7, when positioning is performed based on GPS, validation of each piece of locational information of players acquired based on GPS characteristic values may be assessed. For example, FIG. 19 illustrates validity determination criteria for locational information of a player according to one embodiment of the present disclosure, and FIG. 20 illustrates a threshold time length for validity determination of locational information of a player according to one embodiment of the present disclosure. As shown in FIG. 19, for example, regarding the locational information of a specific player at a particular time point, various metrics representing positioning states may be used to establish criteria for validity determination, where the metrics may include at least one or all of the positioning states at the time the locational information is acquired, for example, the number of satellites used to acquire the information, the measurement mode in which the information is acquired, the accuracy of the velocity associated with the information, and the strength of signals received at the time the information is acquired. Also, according to one aspect of the present disclosure, as shown in FIG. 20, a threshold time may be established to validate the acquired data based on whether the conditions above are satisfied. If the condition for invalid data is met for a predetermined time period, the data acquired from the time point onward may be processed as invalid, and once the invalidation condition is lifted, the data acquired from that time point onward may be processed as valid. The procedure for determining validity of locational information of a sports player according to the embodiments of the present disclosure will be described in more detail later in this document.

Referring back to FIG. 7, based on the locational information of a player according to the missing value imputation procedure S720 and the validation procedure S730, a preprocessing and filtering procedure S740 may be performed.

For a sequence of continuous data, data processing through moving average may be applied. In other words, instead of using the measurement value at a specific first time point, a processed measurement value derived based on the measurements at that time point and/or at neighboring time points may be used for subsequent metric calculations.

Meanwhile, an outlier filtering procedure may also be performed on a sequence of data. As described above, the validation procedure may be performed on each sensing data at a specific time point, and when moving average is utilized over a plurality of time points, a filtering procedure may be performed for each moving average value.

In this regard, in conventional post-event analysis of a sports event, the moving average or filtering procedure is primarily conducted on a server or cloud where collected data is forwarded or on a data analysis device that receives data from the server or cloud. However, in cases where real-time analysis has to be performed according to the embodiments of the present disclosure, many of the procedures conventionally used for post-event analysis may not be applied. According to the embodiments of the present disclosure, preprocessing and/or filtering procedure for data distinct from conventional post-event analysis may be adopted; furthermore, the preprocessing and/or filtering procedure may be directly performed on an individual device, such as a sensor device, and the processed information may be transmitted to the server or user terminal.

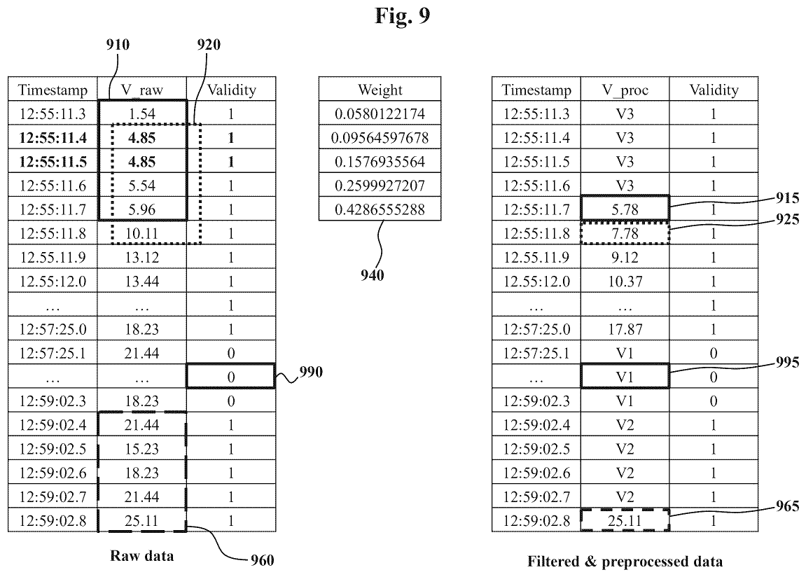

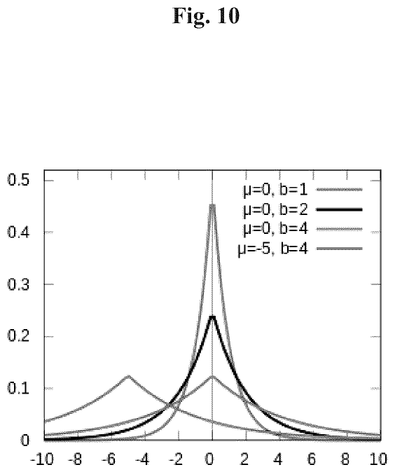

In this regard, FIG. 9 illustrates preprocessing of data according to one embodiment of the present disclosure, and FIG. 10 illustrates a Laplacian distribution. As shown in FIG. 9, according to one aspect of the present disclosure, information related to speed may be subject to preprocessing and filtering. For example, the moving average value of speed measurements within the time interval 910 from 12:55:11.3 to 12:55:11.7 may be used as the processed speed value 915 at 12:55:11.7. The processed speed value may be determined by applying different weights to past values and summing them, using a Laplacian distribution as illustrated in FIG. 10.

To determine the processed information 915 at a specific time point by considering the characteristics of real-time analysis, information at the corresponding time point and/or previous time points 910 before the corresponding time point may be used, while data acquired after the corresponding time point may not be utilized in determining the processed speed value at the corresponding time point. Also, as shown in the preprocessed and filtered data on the right side of FIG. 9, particular processing results, such as V1, V2, and V3, may be identified as erroneous values instead of being assigned as moving average values, and the corresponding data may be filtered. The preprocessing and/or filtering procedures according to the embodiments of the present disclosure will be described in more detail later in this document.

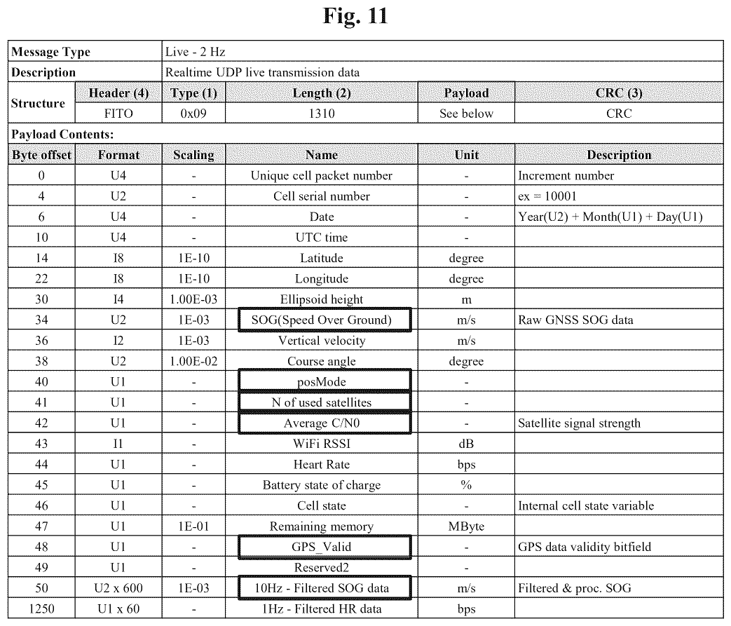

Referring back to FIG. 7, the processed data (Proc. Data) may be formatted into live packets for real-time analysis or into a specific file format for post-event analysis through a packetizing stage. For example, as described with reference to FIG. 5, for post-event analysis, the processed data may be formatted into a specific file format and transmitted to a computing device for sports analysis via storage 510, such as a docking station; alternatively, as described with reference to FIG. 6, for real-time analysis, the processed data may be processed into live packets and directly transmitted to a live hub 610 or a user terminal 1700. In this regard, FIG. 11 illustrates an exemplary structure of a live packet according to one embodiment of the present disclosure. As illustrated in FIG. 11, packets for real-time analysis may include, but are not limited to, at least a portion of sensor-based measured speed (SOG), information on the positioning mode (posMode), the number of satellites used for positioning, average signal strength (Average C/NO), validation information for GPS values (GPS_Valid), and filtered SOG data.

### Validation of Locational Information of a Player

In what follows, a method for collecting information on the location of a sports player in real-time according to an embodiment of the present disclosure, particularly, a procedure for determining validity of acquired information, will be described. In what follows, it is assumed that the system 1000 described above performs the procedure for acquiring real-time player information; however, the description is provided only for the convenience of description, and therefore, the present disclosure is not limited to the specific situation in which the procedure is performed by the system.

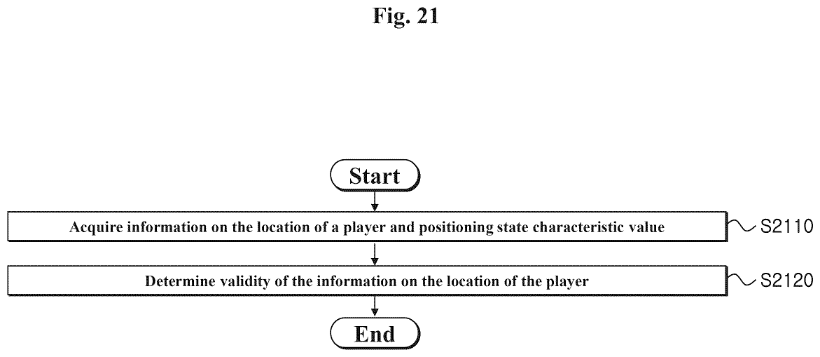

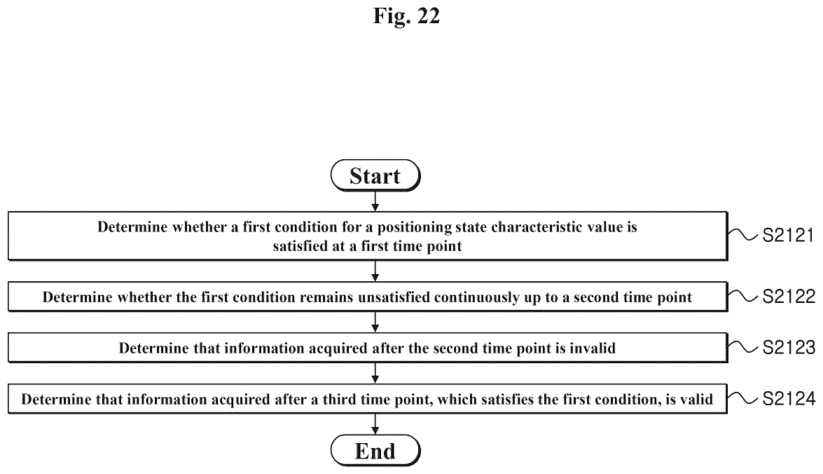

FIG. 21 is a schematic flowchart of a procedure for determining validity of information on the location of a sports player according to one embodiment of the present disclosure, and FIG. 22 is a detailed flowchart of the validity determination in FIG. 21. In what follows, a validity determination procedure for information on the location of a sports player according to one embodiment of the present disclosure will be described in more detail with reference to FIGS. 21 to 22.

For example, the method according to the embodiment of the present disclosure may be performed by a computing device. For the convenience of description, methods according to the embodiments of the present disclosure may be explained as being performed by a computing device. Here, the computing device may include, but is not limited to, at least one of the sensor device 1300, the server 1500, or the terminal 1700; it should be understood that the computing device may include at least one computing device capable of performing operations, including a processor. However, in collecting information on the location of a sports player in real-time according to one embodiment of the present disclosure, specific procedures may be directly performed by the sensor device 1300, which will be described later in this document.

The method for collecting real-time location information of a sports player according to embodiments of the present disclosure may include, as illustrated in FIG. 21, acquiring location information of the player and at least one positioning state characteristic value (2110), and determining validity of the acquired player location information based on the obtained information (2120).

More specifically but not exclusively, as shown in FIG. 21, the computing device may first acquire, based on a positioning sensor, information on the location of a player at a plurality of time points according to predetermined time intervals and at least one positioning state characteristic value S2110.

According to one aspect of the present disclosure, the positioning sensor may be, for example, a Global Navigation Satellite System (GNSS) sensor. More specifically but not exclusively, the positioning sensor may be a GPS sensor included in the sensor device 1300 but is not necessarily limited to the specific example. Also, the predetermined time interval may be 0.1 seconds, as illustrated with reference to FIG. 8, but is not limited to the specific case.

Here, the positioning state characteristic value may include information on the positioning state at the time the positioning sensor determines the locational information of a player. For example, the GPS characteristic values illustrated in FIG. 7 may be included as exemplary positioning state characteristic values. In other words, when information on the location of a player is determined, various indicators representing the environment and/or conditions under which the locational information of the player has been determined may be included in the positioning state characteristic values.

As a non-exhaustive example, when the positioning sensor senses the player's locational information based on satellite signals according to one aspect of the present disclosure, the positioning state characteristic value may include at least one of information on the number of satellites used for positioning of the positioning sensor, information on the positioning mode of the positioning sensor, accuracy information of the vertical position of the positioning sensor, or information on the strength of satellite signals received by the positioning sensor. In this regard, the computing device may receive not only the player's locational information from the positioning sensor but also various supplementary information related to positioning.

For example, as illustrated in the live packet of FIG. 11, the positioning device may basically sense not only the information on the time point for positioning a target but also information on the latitude, altitude, and height. In addition, the positioning device may provide information on the ground direction speed of the target at the positioning time and may also provide information on the vertical speed. Furthermore, the positioning device may provide a value related to posMode, which indicates the mode in which positioning is performed at the corresponding time. In this regard, as described above, RTK-GPS with improved accuracy may be used for positioning according to an embodiment of the present disclosure; in this case, RTK-GPS may identify the positioning mode at the positioning time as one of R/A/D/N modes. For example, the R mode indicates that positioning is performed using the RTK-GPS mode; the A mode, known as the Adaptive mode, indicates that positioning is performed with an accuracy level corresponding to the level when positioning is performed in the absence of surrounding obstacles; the D mode, known as the Dynamic mode, indicates that positioning is performed in an environment with some obstacles, such as a half-dome stadium, but where normal positioning results are still obtained with an appropriate level of accuracy; and the N mode, known as the Noise mode, indicates that positioning is performed with a large error at a location near steel structures or indoors. In addition to the cases above, the positioning sensor may provide various supplementary information along with the positioning information, such as the number of satellites used for positioning and the strength of satellite signals received at the positioning time point.

According to one aspect of the present disclosure, to determine validity of positioning data obtained by a positioning sensor at a specific time point, information indicating the state and/or environment at the time of positioning, for example, the positioning state characteristic information may be used among the supplementary information; the positioning state characteristic values may include, but are not limited to, at least one of the information on the number of satellites used for positioning, information on the positioning mode of the positioning sensor, accuracy of the vertical position of the positioning sensor, or information on the strength of satellite signals received by the positioning sensor.

Referring back to FIG. 21, the computing device may determine validity of the locational information of a player based on the positioning state characteristic value obtained from the positioning sensor S2120. In other words, the computing device may be configured to determine whether the acquired locational information of the player at a specific time point is valid by utilizing the positioning state characteristic value at that time.

According to one aspect of the present disclosure, the computing device may establish a first condition to determine validity. More specifically but not exhaustively, the first condition may be a combination of various positioning state values but is not limited thereto.

As previously described, in an exemplary embodiment where the positioning sensor performs positioning based on satellite signals, the first condition may include a combination of various state values related to satellite signals.

More specifically but not exhaustively, FIG. 19 illustrates validity determination criteria for locational information of a player according to one embodiment of the present disclosure, and FIG. 20 illustrates a threshold time length for validity determination of locational information of a player according to one embodiment of the present disclosure.

For example, as shown in FIG. 19, the first condition may be satisfied only when all specific conditions for a plurality of positioning state characteristic values included in the first condition are met. For example, the specific conditions may include conditions 1 to 4, as shown in FIG. 19 but are not limited thereto.

According to one aspect of the present disclosure, the specific conditions may include whether the number of satellites used for positioning of the positioning sensor is larger than or equal to six (condition 1). Also, according to one aspect, the specific conditions may further include whether the positioning mode of the positioning sensor is RTK-GPS mode or a normal mode (condition 2). For example, as described above, the normal mode may correspond to, but is not limited to, A mode or higher in the posMode. Furthermore, according to one aspect, the specific conditions may include whether accuracy of a vertical position of the positioning sensor is less than or equal to 3 m (condition 3). Also, the specific conditions may further include whether accuracy of the speed of the positioning sensor is less than or equal to a predetermined threshold value. Meanwhile, according to one aspect, the specific conditions may further include whether the strength of satellite signals received by the positioning sensor is larger than or equal to 20 dB (condition 4).

In other words, in the non-limiting example, the first condition may be set to be satisfied only when positioning is performed based on signals from six or more satellites, the positioning mode is RTK-GPS mode or normal mode, accuracy of a vertical position is less than or equal to 3 m, and the received satellite signal strength is larger than or equal to 20 dB.

As illustrated in FIG. 19, if the information on the location of a player at a specific time point is determined to be valid, the validity value of the locational information, such as the GPS_Valid field, may be set to 1; if the locational information is determined to be invalid, the value may be set to 0.

In this regard, according to one aspect of the present disclosure, the validity of the locational information of a player at a specific time point may be determined based on the relationship between the duration of the first condition being satisfied or unsatisfied and the threshold time length. For example, if the first condition remains unsatisfied for a predetermined period, 3 seconds or longer in the example of FIG. 19, a warning state is triggered, the arming flag is set to 1, and locational information of a player acquired after that time point may be determined to be invalid. On the other hand, if the first condition is satisfied while the warning state is in effect, the warning state is lifted, the disarming flag is set to 1, and locational information of the player acquired after that time point may be determined to be valid.

More specifically, according to one aspect of the present disclosure, as illustrated in FIG. 22, the computing device may first determine that the first condition is not satisfied for the positioning state characteristic value at a first time point S2121, evaluate continuously the satisfaction of the first condition, and determine that the locational information of the player acquired after the second time point is invalid S2123 in response to the determination that the first condition remains unsatisfied for a predetermined threshold time interval extending from the first time point to a second time point S2122. For example, the threshold time interval may be set to 3 seconds, and, as shown in FIG. 20, if condition 1 is not satisfied, for example, from 0 to 3 seconds, leading to a determination that the first condition is not satisfied, the arming flag may be set to 1, and locational information of the player acquired after 3 seconds may be determined to be invalid.

Referring again to FIG. 22, the computing device may determine that locational information of the player acquired after a third time point is valid S2124, where the first condition is satisfied for the first time at the third time point after the second time point. For example, as illustrated in FIG. 20, if all specific conditions are satisfied again at t=9 s and the first condition is determined to be satisfied, the disarming flag may be set to 1, and locational information of the player acquired after that time point may be determined to be valid.

As described above, when sports analysis is performed in real-time according to embodiments of the present disclosure, validity of collected information on the location of the player may be determined by the procedures that differ from those employed in the post-event analysis. Meanwhile, in one aspect of the present disclosure, the computing device that performs real-time data collection and validation of the collected data according to the embodiment of the present disclosure may be a wearable device attached to a sports player. In other words, unlike in post-event analysis, the data collection and validation procedures described above may be performed by a processor embedded in a device, e.g., the sensing device, used to acquire locational information of the player.

### Validation Based on Motion Detection

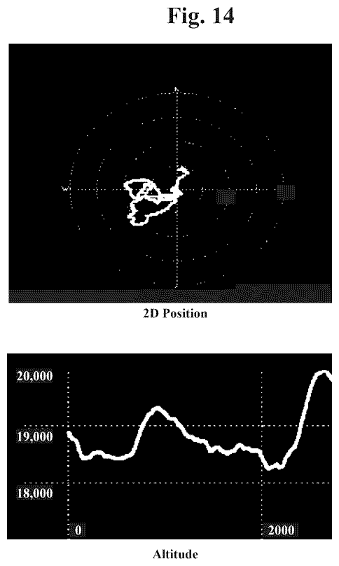

FIG. 14 illustrates a location measurement result for a stationary device using a conventional GPS device. As illustrated in FIG. 14, in a conventional GPS device, even when a sensor device equipped with a GPS module remains fixed at a specific location without being used for a predetermined time period, movement by a predetermined distance may still be detected due to errors in the GPS sensor. As shown in FIG. 14, a device that has not actually moved in the two-dimensional space may appear to have moved randomly in different directions; similarly, a device that has not undergone any actual change in the altitude position may be observed to have variations in the height. Errors caused by the GPS characteristics above may be referred to as the so-called GPS ghosting; even if a positioning error does not yield a significantly large value, the positioning error may lead to considerable reduction of reliability when a total movement distance is calculated for a specific device.

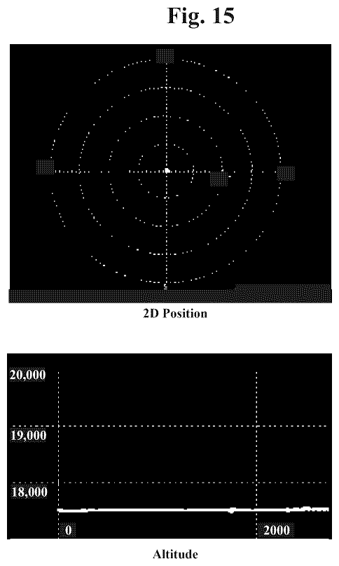

According to one aspect of the present disclosure, the problem above may be resolved by using an inertial sensor that determines whether actual movement has occurred for the device and disregarding displacement detected by the positioning sensor when no movement is present. In this regard, FIG. 15 illustrates a location measurement result for a stationary device according to one embodiment of the present disclosure. As shown in FIG. 15, according to one embodiment of the present disclosure, a stationary device may be observed as having no detected displacement in the two-dimensional and vertical directions and thus remaining at a fixed location.

In what follows, in a method for collecting information on the location of a sports player in real-time according to an embodiment of the present disclosure, particularly, a procedure for determining validity of acquired information based on the occurrence of movement will be described. In the following description, it is assumed that the system 1000 performs the procedure for real-time acquisition of player information; however, the assumption is introduced only for the convenience of description but this is only for convenience of description and does not necessarily limit the procedure to being performed by the system.

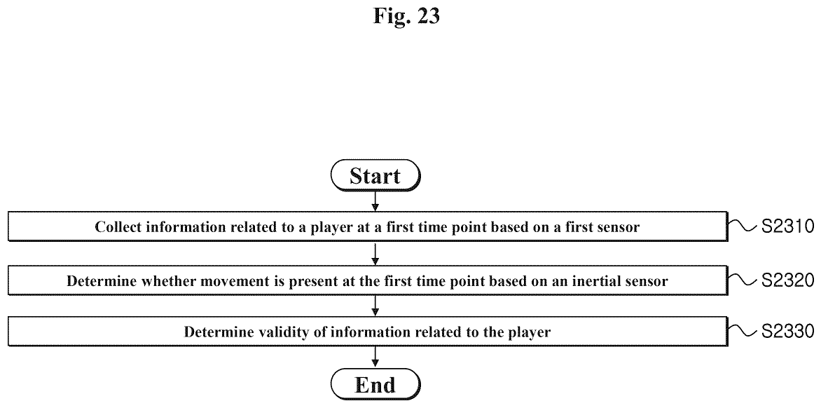

FIG. 23 is a schematic flowchart of a procedure for determining validity of information on the location of a sports player based on an inertial sensor according to one embodiment of the present disclosure. In what follows, the inertial sensor-based validity determination procedure for locational information of a sports player according to one embodiment of the present disclosure will be described in more detail with reference to FIG. 23.

For example, the method according to the embodiment of the present disclosure may be performed by a computing device. For the convenience of description, methods according to the embodiments of the present disclosure may be explained as being performed by a computing device. Here, the computing device may include, but is not limited to, at least one of the sensor device 1300, the server 1500, or the terminal 1700; it should be understood that the computing device may include at least one computing device capable of performing operations, including a processor. However, in collecting information on the location of a sports player in real-time according to one embodiment of the present disclosure, specific procedures may be directly performed by the sensor device 1300, which will be described later in this document.

The method for collecting information on the location of a sports player in real-time according to embodiments of the present disclosure may include, as illustrated in FIG. 23, acquiring information on a sports player at a first time point based on a first sensor S2310, acquiring information on whether movement is detected by an inertial sensor at the first time point S2320, and determining validity of the information on the sports player information based on the information on whether movement is detected by the inertial sensor S2330.

In what follows, the inertial sensor-based procedure according to embodiments of the present disclosure will be described in more detail with reference to FIG. 23. More specifically but not exhaustively, as illustrated in FIG. 23, the computing device may first acquire information on the sports player at a first time point based on a first sensor S2310.

Here, according to one aspect of the present disclosure, the first sensor may be a Global Navigation Satellite System (GNSS) sensor, and the information related to the sports player may be information related to the speed of the sports player. For example, as illustrated in FIGS. 15 to 16, locational information of the sports player may be sensed based on the positioning sensor, where, for example, the locational information may correspond to the information related to the speed of the sports player. The speed information may be a value calculated based on the measured locational information or a value provided by a satellite-based positioning mechanism such as GPS.

Also, according to another aspect of the present disclosure, the first sensor may be a heart rate (HR) sensor, and the information related to the sports player may be information related to the heart rate of the sports player. For example, as illustrated in FIG. 3, the first sensor may be included in a biosensing module 1317 within the sensor device 1300. The biosensing module 1317 may be a heart rate sensor configured to measure the heart rate of the player corresponding to the sensor device. Although a heart rate sensor is provided as an example, it should be understood that various biometric signal measurement devices, such as an electrocardiogram (ECG) sensor, may be included within the technical scope of the present disclosure.

Referring back to FIG. 23, the computing device may collect information on whether movement is detected by the inertial sensor at the first time point S2320. The inertial sensor may be included in a motion sensing module 1315 included in the sensor device 1300, as illustrated in FIG. 3. According to one aspect of the present disclosure, the inertial sensor may be an IMU sensor but is not limited thereto.

For example, the motion sensor such as the IMU sensor may be configured to provide not only measurement values related to the degree of movement but also flag information indicating whether movement is detected at a specific time point. The movement flag information may be set to have a minimal bit size. For example, the movement flag information may be set to have a value of 1 when movement is detected by the inertial sensor and a value of 0 when no movement is detected; however, this is merely an exemplary configuration, and the present disclosure is not limited to the specific configuration.

Referring back to FIG. 23, the computing device may determine validity of the information related to the sports player based on whether movement is detected by the inertial sensor S2330. According to one aspect of the present disclosure, if no movement is detected by the inertial sensor based on the movement flag information, the information related to the sports player collected using the first sensor may be determined to be invalid. Also, according to one aspect, if no movement is detected by the inertial sensor and the magnitude of the collected information related to the player is less than or equal to a threshold value, the magnitude of the collected information related to the player may be set to zero.

As a more specific but non-limiting example, when the first sensor is a positioning sensor, the computing device may change the information related to the speed of the sports player to zero in response to the determination that no movement is detected by the inertial sensor and that the sports player's speed is below a predetermined threshold. In other words, if movement or speed is detected due to the error in the GPS sensor measurements, such as the GPS sensing values illustrated in FIG. 14, the computing device may acquire information related to the presence of movement from the inertial sensor; if the inertial sensor indicates that no movement is present, and the information measured by the positioning sensor, such as the information related to the speed of the player, is less than or equal to a preset threshold, the computing device may change the measured speed value to zero. Accordingly, even if displacement or speed is detected due to errors in the GPS measurements while the device has not actually moved, the GPS ghosting problem may be resolved by changing the displacement or speed value to zero.

As another specific but non-limiting example, when the first sensor is a heart rate (HR) sensor or an electrocardiogram (ECG) sensor, the computing device may change the information related to the heart rate of the sports player to zero in response to the determination that no movement is detected by the inertial sensor. For example, if a sensor device is detached from the docking station and placed in a state exhibiting a specific condition, such as being exposed to certain substances or moisture, heart rate or ECG signals may be measured even though the sensor device is not worn by the player. According to one embodiment of the present disclosure, the system may acquire information related to the presence of movement from the inertial sensor and change the value of a biometric signal measured by the heart rate sensor or ECG sensor to zero if the inertial sensor measurements indicate that no movement is present. More specifically, the system may be configured to change the measured sensing value to zero only if no movement is detected by the inertial sensor and the measured sensing value is less than or equal to a threshold value. Therefore, the example above may prevent the heart rate or ECG data from being measured and recorded even through the sensor device is not worn by the player.

As described above, when sports analysis is performed in real-time according to embodiments of the present disclosure, validity of collected information related to the player may be determined by the procedures that differ from those employed in the post-event analysis. Meanwhile, in one aspect of the present disclosure, the computing device that performs real-time data collection and validation of the collected data according to the embodiment of the present disclosure may be a wearable device attached to a sports player. In other words, unlike post-event analysis, the data collection and validation procedures described above may be performed by a processor embedded in a device, e.g., the sensing device, used to acquire locational information of the player.

### Preprocessing and Filtering for Real-Time Analysis

As described with reference to FIG. 7, according to one embodiment of the present disclosure, the preprocessing and filtering procedure S740 may be performed on the sensing information acquired from the sensor device.

For a sequence of continuous data, data processing through moving average may be applied. In other words, instead of using the measurement value at a specific first time point, a processed measurement value derived based on the measurements at that time point and/or at neighboring time points may be used for subsequent metric calculations.

Meanwhile, an outlier filtering procedure may also be performed on a sequence of data. As described above, the validation procedure may be performed on each sensing data at a specific time point, and when moving average is utilized over a plurality of time points, a filtering procedure may be performed for each moving average value.

In this regard, in conventional post-event analysis of a sports event, the moving average or filtering procedure is primarily conducted on a server or cloud where collected data is forwarded or on a data analysis device that receives data from the server or cloud. However, in cases where real-time analysis has to be performed according to the embodiments of the present disclosure, many of the procedures conventionally used for post-event analysis may not be applied. According to the embodiments of the present disclosure, preprocessing and/or filtering procedure for data distinct from conventional post-event analysis may be adopted; furthermore, the preprocessing and/or filtering procedure may be directly performed on an individual device, such as a sensor device, and the processed information may be transmitted to the server or user terminal.

In what follows, in a method for collecting information on the location of a sports player in real-time according to an embodiment of the present disclosure, particularly, a preprocessing and/or filtering procedure for information acquired by a sensor device will be described. In the following description, it is assumed that the system 1000 performs the procedure for real-time acquisition of player information; however, the assumption is introduced only for the convenience of description but this is only for convenience of description and does not necessarily limit the procedure to being performed by the system.

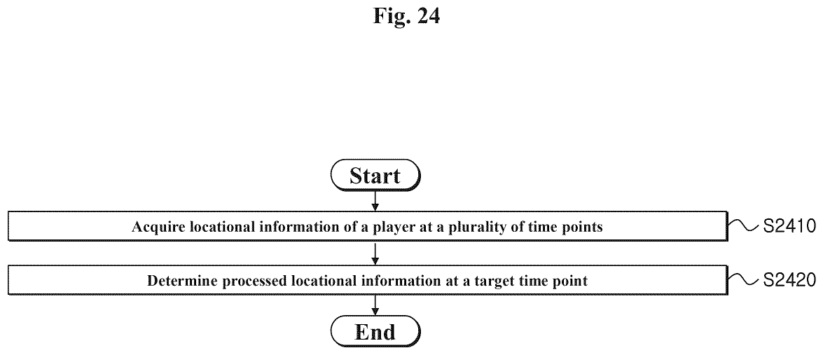

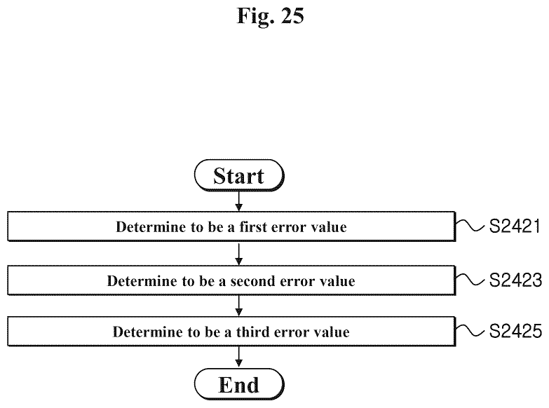

FIG. 24 is a schematic flowchart of a procedure for collecting information on the location of a sports player in real-time based on preprocessing according to one embodiment of the present disclosure, and FIG. 25 is a detailed flowchart of the determining of processed locational information at the target time point in FIG. 24. In what follows, with reference to FIGS. 24 to 25, a procedure for collecting information on the location of a sports player in real-time based on preprocessing according to one embodiment of the present disclosure will be described in more detail.

For example, the method according to the embodiment of the present disclosure may be performed by a computing device. For the convenience of description, methods according to the embodiments of the present disclosure may be explained as being performed by a computing device. Here, the computing device may include, but is not limited to, at least one of the sensor device 1300, the server 1500, or the terminal 1700; it should be understood that the computing device may include at least one computing device capable of performing operations, including a processor. However, in collecting information on the location of a sports player in real-time according to one embodiment of the present disclosure, specific procedures may be directly performed by the sensor device 1300.

The method for collecting information on the location of a sports player in real-time based on preprocessing according to embodiments of the present disclosure may include, as illustrated in FIG. 24, acquiring locational information of a player at a plurality of time points S2410 and determining processed locational information at the target time point S2330.

In what follows, with reference to FIGS. 24 to 25, a method for collecting information on the location of a sports player in real-time based on preprocessing according to an embodiment of the present disclosure will be described in more detail. More specifically but not exhaustively, as illustrated in FIG. 24, the computing device may first acquire, based on a positioning sensor, information on the location of a player at a plurality of time points according to a predetermined time interval S2410.

According to one aspect of the present disclosure, the positioning sensor may be, for example, a Global Navigation Satellite System (GNSS) sensor. More specifically but not exclusively, the positioning sensor may be a GPS sensor included in the sensor device 1300 but is not necessarily limited to the specific example. The predetermined time interval may be 0.1 seconds, as indicated in the time stamp field, but is not limited to the specific case. In other words, the expected sampling rate of the information may be 10 Hz. The measured data may correspond to speed at measurement intervals, as illustrated in FIG. 8, where the speed value of the target player is measured at each time point.

According to one aspect, the acquiring of the information on the location of the player at a plurality of time points S2410 may be configured to replace the information on the location of the player at a first time point, which is missing based on the predetermined time interval, with the information on the location of the player at a previous time point before the first time point. The missing data may be caused by a discrepancy between the sampling period of the positioning sensor and the predetermined time interval, but the present disclosure is not limited to the specific case. For example, the missing value imputation procedure may be performed as described with reference to FIG. 8.

Referring again to FIG. 24, the computing device may determine processed locational information for the target time point based on the information on the location of the player measured at a predetermined number of time points preceding the target time point S2420.

According to one aspect of the present disclosure, the processed locational information for the target time point may be determined independently of the information on the location of the player measured after the target time point. Accordingly, for real-time analysis, the present disclosure provides an advantageous effect of acquiring processed locational information with improved accuracy and robustness to the risk of error occurrence while using only past information up to the current time point without relying on future data after the current time point.

Also, according to one aspect of the present disclosure, the processed locational information for the target time point may be determined by multiplying the information on the location of the player measured at each of the predetermined number of time points by different weights and summing the multiplication results; more specifically but not exhaustively, the weights may be determined based on a Laplacian distribution or a Gaussian distribution but are not limited to the specific case.

In this regard, FIG. 9 illustrates preprocessing of data according to an embodiment of the present disclosure, and FIG. 10 illustrates a Laplacian distribution. In what follows, as an example of preprocessed locational information, the preprocessed speed information is described; however, it should be noted that the technical principles of the present disclosure are not limited to the specific description.

As shown in FIG. 9, according to one aspect of the present disclosure, information related to speed may be subject to preprocessing and filtering. For example, the weighted average value of speed measurements within the time interval 910 from 12:55:11.3 to 12:55:11.7 may be used as the processed speed value 915 at 12:55:11.7. The processed speed value may be determined by applying different weights to past values and summing them, using a Laplacian distribution as illustrated in FIG. 10.

Exemplary weight values 940 are illustrated in FIG. 9. In other words, for example, when the predetermined number of past measurement values used for weighted averaging at a specific time point is five, five weights may be determined based on a Laplacian distribution, as shown in FIG. 9; to calculate the processed speed value at the first time point 915 illustrated in FIG. 9, the speed values from five time points within the first time interval 910 may be sequentially multiplied by the five weights and summed.

Similarly, to calculate the processed speed value at the second time point 925 illustrated in FIG. 9, the speed values from five time points within the second time interval 920 may be sequentially multiplied by the five weights and summed; likewise, to calculate the processed speed value at the third time point 965 illustrated in FIG. 9, the speed values from five time points within the third time interval 960 may be sequentially multiplied by the five weights and summed.

According to one aspect of the present disclosure, the predetermined number of past time points that may be used to determine the processed locational information at a target time point may be determined by considering the sampling rate of the positioning sensor used for sensing locational information and the data transmission cycle of the computing device. More specifically but not exhaustively, the predetermined number of past time points that may be used to determine the processed locational information at a target time point may be determined so that locational information is processed according to the sampling rate of the positioning sensor and no waiting time occurs due to the data transmission cycle of the computing device. As a more specific but non-limiting example, the sensing device and/or the GPS module included therein may be configured to sense locational information at a sampling rate of 10 Hz, while the computing device may be configured to transmit data to another device at a data transmission rate of 2 Hz. Therefore, while the computing device transmits data once, the sensing device and/or the GPS module may sense locational information at five time points. If more than five past time points are referenced to determine the processed locational information at the target time point, data may not be transmitted to acquire locational information at additional time points even when the data transmission cycle is reached, resulting in a time delay for acquiring additional locational information. Therefore, according to one aspect of the present disclosure, the predetermined number of past time points used to determine the processed locational information at a target time point may be set by considering the sampling period of the positioning sensor for sensing the locational information and the data transmission cycle of the computing device so that no waiting time is occurred for data transmission. According to one aspect of the present disclosure, the predetermined number of past time points may be set to be equal to the number of pieces of locational information included in a single packet according to the data transmission cycle of the computing device.

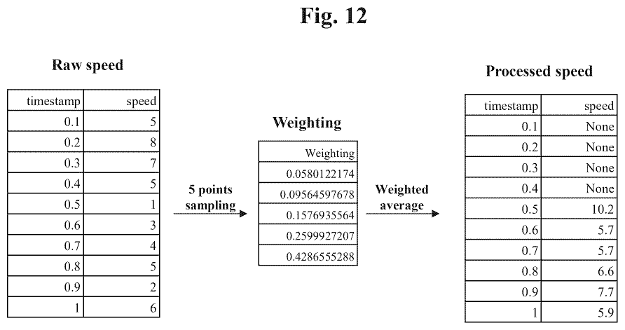

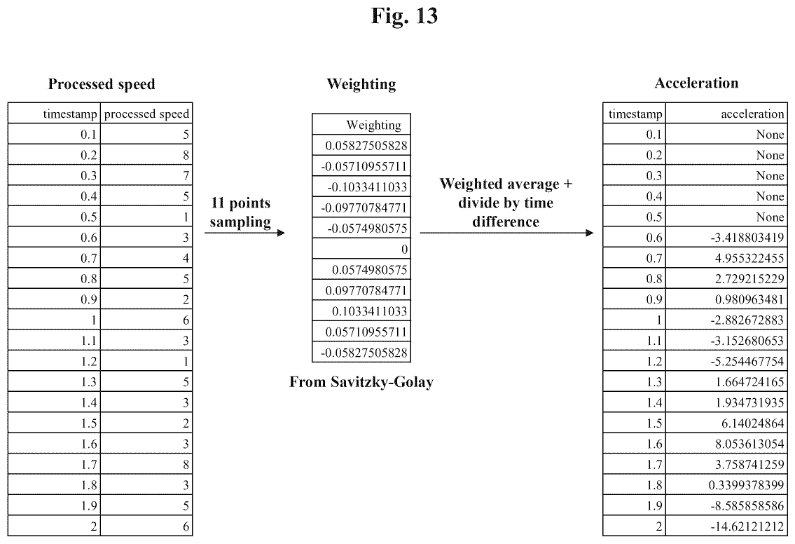

FIG. 12 illustrate preprocessing for speed information according to one embodiment of the present disclosure, and FIG. 13 illustrates preprocessing for acceleration information according to one embodiment of the present disclosure. As illustrated in FIGS. 12 to 13, different preprocessing mechanisms may be applied to speed information and acceleration information. As shown in FIG. 12, for speed information, five time points may be used, but only the measurement information at time points preceding the target time point may be subject to weighted operation of the preprocessing. On the other hand, as illustrated in FIG. 13, for acceleration information, eleven time points may be used, and both the measurement information at time points preceding the target time point and those at time points after the target time point may be subject to weighted operation. The operations above may be determined based on the accuracy of the moving average calculation for speed and acceleration but are not limited thereto. When real-time analysis is performed, if measurement information at time points after the target time point is to be utilized, such as when acceleration is calculated, the analysis may effectively be delayed by, for example, the five time points.

As described above, to determine the processed information 915 at a specific time point by considering the characteristics of real-time analysis, information at the corresponding time point and/or previous time points 910 before the corresponding time point may be used, while data acquired after the corresponding time point may not be utilized in determining the processed speed value at the corresponding time point. Also, as shown in the preprocessed and filtered data on the right side of FIG. 9, particular processing results, such as V1, V2, and V3, may be identified as erroneous values instead of being assigned as moving average values, and the corresponding data may be filtered.

In this regard, as shown in FIGS. 24 to 25, determining processing locational information for the target time point S2420 may include determining processed locational information for the target time point as a first error value S2421, determining processed locational information for the target time point as a second error value S2423, and determining processed locational information for the target time point as a third error value S2425.

More specifically but not exhaustively, the computing device may determine the processed locational information for the target time point as a first error value in response to the determination that the information on the location of the player measured based on the positioning sensor at the target time point is invalid S2421. As described according to one aspect of the present disclosure, validity may be determined for each piece of information on the location of a player at the respective time points. According to one aspect, validity may be determined based on the positioning state characteristic value, but the present disclosure is not limited to the specific case. In this regard, if locational information of the player at the target time point is determined to be invalid, the processed locational information determined based on the measurements at preceding time points may be set to a first error value. As illustrated in FIG. 9, for invalid locational information where the validity at the corresponding time point is marked as 0, the processed locational information may be determined to be the first error value V1, e.g., 995.

Also, according to one aspect, the computing device may determine the processed locational information for the target time point as a second error value in response to the determination that at least one of the pieces of information on the location of the player measured at a predetermined number of time points preceding the target time point is invalid S2423. In other words, as shown in FIG. 9, since the measurement information from 12:57:25.1 to 12:59:02.3 is invalid, although the measurement information at the target time point itself is valid, if any one of the invalid time points are included in the weighted application, the processed locational information at the time points in which any one of the invalid time points is included as a target of weighted calculations, i.e., time points from 12:59:02.3 to 12:59:02.7, may be determined to be the second error value V2.

Meanwhile, according to one aspect, the computing device may determine the processed locational information for the target time point as a third error value in response to the determination that the number of pieces of information on the location of the player measured at time points preceding the target time point is smaller than a predetermined number of time points S2425. In other words, since the number of pieces of measurement information before the application of weighted calculation is smaller than the predetermined number for the time period from 12:55:11.3 to 12:55:11.6, the processed locational information may be determined to be the third error value V3.

According to the embodiments of the present disclosure, the preprocessing and/or filtering procedure described above may be performed.

Also, as described above, when sports analysis is performed in real-time according to embodiments of the present disclosure, preprocessing may be performed on the collected information related to the player by the procedures that differ from those employed in the post-event analysis. Meanwhile, in one aspect of the present disclosure, the computing device that performs real-time data collection and preprocessing and/or filtering procedure according to the embodiment of the present disclosure may be a wearable device attached to a sports player. In other words, unlike post-event analysis, the preprocessing and filtering procedure described above may be performed by a processor embedded in a device, e.g., the sensing device, used to acquire locational information of the player.

### Ensuring Consistency Between Post-Event Analysis and Real-Time Analysis

Due to at least a portion of the data validation, preprocessing, or filtering procedure described above in the present disclosure, the accuracy of the locational information of a player for real-time analysis may be improved, which provides an advantageous effect of enhancing consistency between post-event analysis and real-time analysis of a sports event.

Additionally, according to embodiments of the present disclosure, at least part of various features designed to improve consistency between post-event analysis and real-time analysis of a sports event may be employed.

As an example, issues related to floating-point discrepancies arising from differences between the operating languages of computing devices used for post-event analysis and those used for real-time analysis may be considered. For example, various criteria may be set when sports analysis is performed. For example, a speed threshold of 10 m/s may be used to classify a specific action, which may be converted to 36 km/h. However, depending on the operating language of the computing device, a floating-point error may be introduced when converting 10 m/s to km/h through computational operations. For example, in one operating language, converting 10 m/s to km/h units may result in 36.0001 km/h, whereas in another operating language, it may result in 36.00002 km/h, leading to a discrepancy between the two.

In other words, floating-point issues may arise. For example, when an if statement check, i.e., the HSR threshold of 19.8 km/h is divided by 3.6 to convert the HSR threshold into a value in SI units, a computing device for real-time analysis, such as a tablet PC, may may produce 5.5000000034, whereas a computing device used for post-event analysis, such as a web server, may produce 5.5000000023, leading to a discrepancy problem.

Therefore, instead of sending a phenotypic threshold and having each device convert it into its own computational threshold, metric calculations may be performed by sending both the phenotypic value and the computational value to synchronize thresholds between live and web-based systems. For example, to ensure consistency between real-time analysis and post-event analysis according to one aspect of the present disclosure, unit conversion for specific thresholds is not performed separately on each computing device used for real-time and post-event analysis; instead, metric calculations may be performed by transmitting a converted threshold value by one of the devices. For example, the computing device performing post-event analysis may predefine and store threshold values in both m/s and km/h units, and the computing device for real-time analysis may load and utilize the predefined values, thereby enhancing consistency between real-time and post-event analysis.

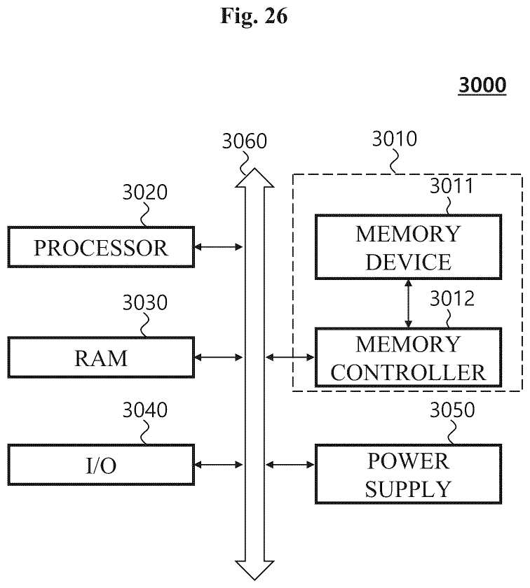

FIG. 26 is a block diagram illustrating an exemplary structure of a computing system in which the method according to one embodiment of the present disclosure may be performed.

Referring to FIG. 26, the computing system 3000 may include flash storage 3010, a processor 3020, RAM 3030, an input/output device 3040, and a power supply 3050. Also, flash storage 3010 may include a memory device 3011 and a memory controller 3012. Meanwhile, although not shown in FIG. 26, the computing system 3000 may further include ports that enable communication with video cards, sound cards, memory cards, USB devices, or other electronic devices.

The computing system 3000 may be implemented as a personal computer or a portable electronic device such as a laptop computer, a mobile phone, a personal digital assistant (PDA), and a camera.

The processor 3020 may perform specific calculations or tasks. Depending on the embodiments, the processor 3020 may be a microprocessor or a central processing unit (CPU). The processor 3020 may communicate with the RAM 3030, the input/output device 3040, and the flash storage 3010 via a bus 3060, which may include an address bus, a control bus, and a data bus.

According to one embodiment, the processor 3020 may also be connected to an expansion bus such as the Peripheral Component Interconnect (PCI) bus.

The RAM 3030 may store data required for the operation of computing system 3000. For example, any type of random access memory, including DRAM, mobile DRAM, SRAM, PRAM, FRAM, MRAM, and RRAM, may be used as RAM 3030.

The input/output device 3040 may include input means such as a keyboard, a keypad, and a mouse; and output means such as a printer and a display. The power supply 3050 may provide the operating voltage necessary for the operation of the computing system 3000.

The method according to the present disclosure described above may be implemented as computer-readable code stored on a computer-readable recording medium. The computer-readable recording medium may include any type of recording medium that stores data readable by a computer system. Examples include a read-only memory (ROM), a random access memory (RAM), a magnetic tape, a magnetic disk, flash memory, and an optical data storage device. Also, the computer-readable recording medium may be distributed across computer systems connected via a computer network and stored and executed in a distributed manner.

In this document, the present disclosure has been described with reference to appended drawings and embodiments, but the technical scope of the present disclosure is not limited to the drawings or embodiments. Rather, it should be understood by those skilled in the art to which the present disclosure belongs that the present disclosure may be modified or changed in various ways without departing from the technical principles and scope of the present disclosure disclosed by the appended claims below.

More specifically, the characteristic features described above may be executed by a digital electronic circuit, computer hardware, firmware, or a combination thereof. The characteristic features may, for example, be executed by a computer program product implemented within a storage apparatus of a machine-readable storage device so that they may be executed by a programmable processor. Moreover, the characteristic features may be executed by a programmable processor which executes a program of instructions for performing functions of the aforementioned embodiments as they are operated based on the input data to produce an output. The characteristic features described above may be executed within one or more computer programs which may be executed on a programmable system including at least one programmable processor, at least one input device, and at least one output device, which are combined to receive data and instructions from a data storage system and to transmit data and instructions to the data storage system. A computer program includes a set of instructions which may be used directly or indirectly within the computer to perform a specific operation with respect to a predetermined result. The computer program may be written by any one of programming languages including compiled or interpreted languages and may be used in any other form including a module, an element, a subroutine, another appropriate unit to be used in a different computing environment, or a program which may be manipulated independently.

Processors appropriate for executing a program of instructions include, for example, both of general-purpose and special-purpose microprocessors, single processor, or multi-processors of a different type of computer. Also, storage devices appropriate for implementing computer program instructions and data which implement the characteristic features described above include all kinds of non-volatile storage devices: for example, semiconductor memory devices such as EPROM, EEPROM, and flash memory devices; internal hard disks; magnetic devices such as removable disks; optical magnetic disks; CD-ROM; and DVD-ROM disks. The processor and memory may be integrated within application-specific integrated circuits (ASICs) or added by the ASICs.

Although the present disclosure is described based on a series of functional blocks, the present disclosure is not limited to the embodiments described above and the appended drawings; rather, it should be clearly understood by those skilled in the art to which the present disclosure belongs that various substitutions, modifications, and variations of the present disclosure may be made without departing from the technical principles and scope of the present disclosure.

A combination of the aforementioned embodiments is not limited to the embodiments described above, but depending on implementation and/or needs, not only the aforementioned embodiments but also a combination of various other forms may be provided.

In the exemplary system described above, methods are described according to a flow diagram by using a series of steps and blocks. However, the present disclosure is not limited to a specific order of the steps, and some steps may be performed with different steps and in a different order from those described above or simultaneously. Also, it should be understood by those skilled in the art that the steps shown in the flow diagram are not exclusive, other steps may be further included, or one or more steps of the flow diagram may be deleted without influencing the technical scope of the present disclosure.

The embodiments described above include examples of various aspects. Although it is not possible to describe all the possible combinations to illustrate the various aspects, it would be understood by those skilled in the corresponding technical field that various other combinations are possible. Therefore, it may be regarded that the present disclosure includes all of the other substitutions, modifications, and changes belonging to the technical scope defined by the appended claims.

What is claimed is:

1. A method for collecting information on the location of a sports player in real-time, performed by a computing device, the method comprising:
acquiring, based on a positioning sensor, information on the location of a player at a plurality of time points according to a predetermined time interval and at least one positioning state characteristic value, wherein the positioning state characteristic value includes information on the positioning state at the time the positioning sensor determines locational information of the player; and
determining validity of the information on the location of the player based on the positioning state characteristic value acquired from the positioning sensor.

2. The method of claim 1, wherein the positioning sensor is a Global Navigation Satellite System (GNSS) sensor.

3. The method of claim 2, wherein the positioning state characteristic value includes at least one of:
information on the number of satellites used for positioning by the positioning sensor;
information on the positioning mode of the positioning sensor;
accuracy information on the vertical position of the positioning sensor; or
information on the strength of satellite signals received by the positioning sensor.

4. The method of claim 3, wherein the information on the positioning mode includes information indicating that the positioning sensor operates according to one of Realtime-kinematic (RTK) GPS mode; normal mode; and noise mode.

5. The method of claim 2, wherein the determining of the validity of the information on the location of the player includes:
determining that a first condition for the positioning state characteristic value is not satisfied at a first time point; and
determining that information on the location of the player obtained after a second time point is invalid in response to the determination that the first condition is not satisfied continuously until the second time point, which is the time point after a predetermined threshold time interval from the first time point.

6. The method of claim 5, wherein the determining of the validity of the information on the location of the player further includes determining that information on the location of the player obtained after a third time point is valid, wherein the third time point is the first time at which the first condition is satisfied after the second time point.

7. The method of claim 5, wherein the first condition states that all specific conditions for a plurality of positioning state characteristic values included in the first condition are satisfied.

8. The method of claim 7, wherein the specific conditions include whether the number of satellites used for positioning by the positioning sensor is six or more.

9. The method of claim 8, wherein the specific conditions further include whether the positioning mode of the positioning sensor is RTK-GPS mode or normal mode.

10. The method of claim 9, wherein the specific conditions further include whether accuracy of a vertical position of the positioning sensor is 3 m or less.

11. The method of claim 10, wherein the specific conditions further include whether strength of satellite signals received by the positioning sensor is 20 dB or higher.

12. The method of claim 1, wherein the computing device is a wearable device attached to a sports player.

13. A device for collecting information on the location of a sports player in real-time, the device comprising a processor; and a memory,
wherein the processor is configured to:
acquire, based on a positioning sensor, information on the location of a player at a plurality of time points according to a predetermined time interval and at least one positioning state characteristic value, wherein the positioning state characteristic value includes information on the positioning state at the time the positioning sensor determines locational information of the player; and
determine validity of the information on the location of the player based on the positioning state characteristic value acquired from the positioning sensor.

14. A computer-readable storage medium including commands executable by a processor, wherein the commands are intended to collect information on the location of a sports player in real-time and, by being executed by the processor, are configured to instruct the processor to:
acquire, based on a positioning sensor, information on the location of a player at a plurality of time points according to a predetermined time interval and at least one positioning state characteristic value, wherein the positioning state characteristic value includes information on the positioning state at the time the positioning sensor determines locational information of the player; and
determine validity of the information on the location of the player based on the positioning state characteristic value acquired from the positioning sensor.

15. A method for collecting information on a sports player in real-time, the method comprising:
collecting information on the sports player at a first time point based on a first sensor;
collecting information on whether movement of an inertial sensor is present at the first time point based on the inertial sensor; and
determining validity of the information on the sports player based on the information on whether movement of the inertial sensor is present.

16. The method of claim 15, wherein the first sensor is a Global Navigation Satellite System (GNSS) sensor,
the information on the sports player is information on the speed of the sports player, and
the determining of the validity of the information on the sports player changes the information on the speed of the sports player to zero in response to the determination that no movement of the inertial sensor is present and that the speed of the sports player is below a predetermined threshold.

17. The method of claim 15, wherein the first sensor is a heart rate (HR) sensor,
the information on the sports player is information on the heart rate of the sports player, and
the determining of the validity of the information on the sports player changes the information on the heart rate of the sports player to zero in response to the determination that no movement of the inertial sensor is present.

18. A device for collecting information on the location of a sports player in real-time, the device comprising a processor; and a memory,
wherein the processor is configured to:
collect information on the sports player at a first time point based on a first sensor;
collect information on whether movement of an inertial sensor is present at the first time point based on the inertial sensor; and
determine validity of the information on the sports player based on the information on whether movement of the inertial sensor is present.

19. A computer-readable storage medium including commands executable by a processor, wherein the commands are intended to collect information on a sports player in real-time and, by being executed by the processor, are configured to instruct the processor to:
collect information on the sports player at a first time point based on a first sensor;
collect information on whether movement of an inertial sensor is present at the first time point based on the inertial sensor; and
determine validity of the information on the sports player based on the information on whether movement of the inertial sensor is present.
